(19) United States
(12) Patent Application Publication
(10) Pub. No.: US 2026/0073658 A1
(43) Pub. Date: Mar. 12, 2026

(54) METHOD PERFORMED BY ELECTRONIC DEVICE, ELECTRONIC DEVICE, AND STORAGE MEDIUM

(71) Applicant: SAMSUNG ELECTRONICS CO., LTD., Suwon-si (KR)

(72) Inventors: Donghan YANG, Beijing (CN); Jiahui Yuan, Beijing (CN); Xianxong Song, Beijing (CN); Jaekeun Na, Suwon-si (CN); Li Zuo, Beijing (CN)

(73) Assignee: SAMSUNG ELECTRONICS CO., LTD., Suwon-si (KR)

(21) Appl. No.: 19/183,503

(22) Filed: Apr. 18, 2025

Related U.S. Application Data
(63) Continuation of application No. PCT/KR2025/002942, filed on Mar. 5, 2025.

(30) Foreign Application Priority Data
Sep. 11, 2024 (CN) 202411273809.1

(51) Int. Cl. G06V 10/26; G06T 7/246; G06T 7/73; G06V 10/40; G06V 10/74; G06V 10/82

(52) U.S. Cl. CPC G06V 10/273; G06T 7/248; G06T 7/74; G06V 10/40; G06V 10/761; G06V 10/82; G06T 2207/10016; G06T 2207/20084; G06V 2201/07

(57) ABSTRACT

A method and an electronic device for performing video object segmentation are provided. The method includes determining a first feature corresponding to a target object in a first image, and/or determining a second feature corresponding to other regions other than the target object in the first image, and performing a first or second processing on a mask feature corresponding to the first image, based on the determined first or second feature. A result of performing the target object segmentation on the first image is determined based on a result of the first processing and/or a result of the second processing.

### CROSS-REFERENCE TO RELATED APPLICATION(S)

This application is a bypass Continuation application of International Application No. PCT/KR2025/002942, filed on Mar. 5, 2025, which claims priority from Chinese Patent Application No. 202411273809.1, filed on Sep. 11, 2024, the disclosures of which are incorporated herein in their entireties by reference.

### TECHNICAL FIELD

The disclosure relates to the field of computer vision technology, and in particular, to a method performed by an electronic device, the electronic device, a storage medium, and a program product.

### BACKGROUND

Image segmentation is one of the important tasks in the field of computer vision technology, which is aimed to divide an image into meaningful and different regions and/or objects, thus helping to better understand, recognize, and/or analyze content of the image. The image segmentation plays a key role in many applications.

Existing image segmentation methods, which generally utilize only pixel-level information for prediction, easily result in erroneous segmentations. For example, when there are other objects in a screen that are similar to a target object, these other objects would likely be erroneously matched to the target object.

### SUMMARY

According to an embodiment of the disclosure, a method performed by an electronic device may include determining, based on an image feature of a first image in a video and a first feature corresponding to a target object in at least one second image for which target object segmentation has been performed in the video, a first feature corresponding to the target object in the first image. The method may include performing, based on the determined first feature, first processing on a mask feature corresponding to the first image. The method may include determining, based on the image feature of the first image and a second feature corresponding to other regions other than the target object in the at least one second image for which the target object segmentation has been performed in the video, a second feature corresponding to the other regions. The method may include performing, based on the determined second feature, second processing on the mask feature corresponding to the first image. The method may include determining, based on a result of the first processing and/or a result of the second processing, a result of performing the target object segmentation on the first image.

According to an embodiment of the disclosure, an electronic device may include at least one memory configured to store a computer program, and at least one processor configured to execute the computer program. The at least one processor may be configured to execute the computer program to perform determining, based on an image feature of a first image in a video and a first feature corresponding to a target object in at least one second image for which target object segmentation has been performed in the video, a first feature corresponding to the target object in the first image. The at least one processor may be configured to execute the computer program to perform performing, based on the determined first feature, first processing on a mask feature corresponding to the first image. The at least one processor may be configured to execute the computer program to perform determining, based on the image feature of the first image and a second feature corresponding to other regions other than the target object in the at least one second image for which the target object segmentation has been performed in the video, a second feature corresponding to the other regions. The at least one processor may be configured to execute the computer program to perform performing, based on the determined second feature, second processing on the mask feature corresponding to the first image. The at least one processor may be configured to execute the computer program to perform determining, based on a result of the first processing and/or a result of the second processing, a result of performing the target object segmentation on the first image.

According to an embodiment of the disclosure, there is provided a non-transitory computer readable storage medium having stored thereon a computer program that, when executed by at least one processor, may perform determining, based on an image feature of a first image in a video and a first feature corresponding to a target object in at least one second image for which target object segmentation has been performed in the video, a first feature corresponding to the target object in the first image. The computer program may perform performing, based on the determined first feature, first processing on a mask feature corresponding to the first image. The computer program may perform determining, based on the image feature of the first image and a second feature corresponding to other regions other than the target object in the at least one second image for which the target object segmentation has been performed in the video, a second feature corresponding to the other regions. The computer program may perform performing, based on the determined second feature, second processing on the mask feature corresponding to the first image. The computer program may perform determining, based on a result of the first processing and/or a result of the second processing, a result of performing the target object segmentation on the first image.

According to an embodiment of the disclosure, there is provided a computer program product including a computer program that, when executed by a processor, implements a method performed by an electronic device according to an embodiment of the disclosure.

### BRIEF DESCRIPTION OF THE DRAWINGS

In order to more clearly explain the technical solutions in the embodiments of the disclosure, the accompanying drawings to be used in the description of the embodiments of the disclosure will be briefly described below.

FIG. 1 illustrates a schematic flowchart of a method performed by an electronic device according to an embodiment of the disclosure;

FIG. 2 illustrates a schematic diagram of three Queries according to an embodiment of the disclosure;

FIG. 3A illustrates a schematic diagram of a processing method of a semantic suppressor module according to an embodiment of the disclosure;

FIG. 3B illustrates a schematic diagram of a comparison of effects before and after semantic suppression of a non-target object using the semantic suppressor module according to an embodiment of the disclosure;

FIG. 4A illustrates a schematic diagram of a processing method of a target attention module according to an embodiment of the disclosure;

FIG. 4B illustrates a schematic diagram of a comparison of effects before and after strengthening a target feature using the target attention module according to an embodiment of the disclosure;

FIG. 4C illustrates an operation of extracting a first feature and/or a second feature corresponding to a second image from a first mask feature according to an embodiment of the disclosure;

FIG. 5 illustrates a schematic diagram of a processing method of a Query generation module according to an embodiment of the disclosure;

FIG. 6A illustrates a schematic diagram of a processing method of a Query updater module according to an embodiment of the disclosure;

FIG. 6B illustrates a schematic diagram of a Query accumulation effect according to an embodiment of the disclosure;

FIG. 7 illustrates a schematic diagram of a processing method using a memory module according to an embodiment of the disclosure;

FIG. 8 illustrates a schematic diagram of a reference feature update mechanism according to an embodiment of the disclosure;

FIG. 9A illustrates a schematic diagram of a reference feature select mechanism according to an embodiment of the disclosure;

FIG. 9B illustrates a process for obtaining a mask feature corresponding to a first image based on a stored mask feature corresponding to a first image feature and the fifth affinity information according to an embodiment of the disclosure;

FIG. 10 is a schematic diagram of a processing method of a Query attention module according to an embodiment of the disclosure;

FIG. 11 illustrates a schematic diagram of a motion evaluation module according to an embodiment of the disclosure;

FIG. 12 illustrates a schematic diagram of an operation of a motion evaluation module according to an embodiment of the disclosure;

FIG. 13 illustrates a schematic diagram of a processing method of a motion track module according to an embodiment of the disclosure;

FIG. 14 illustrates a schematic diagram of a video object segmentation method according to an embodiment of the disclosure;

FIG. 15 illustrates a schematic diagram of another video object segmentation method according to an embodiment of the disclosure;

FIG. 16 illustrates a schematic diagram of an application scenario according to an embodiment of the disclosure;

FIG. 17 illustrates a schematic diagram of another application scenario according to an embodiment of the disclosure; and

FIG. 18 illustrates a schematic diagram of a structure of an electronic device according to an embodiment of the disclosure.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein may be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following descriptions of various embodiments of the disclosure are provided for illustration purposes only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces. When a component is said to be “connected” or “coupled” to the other component, the component may be directly connected or coupled to the other component, or it may mean that the component and the other component are connected through an intermediate element. In addition, “connected” or “coupled” as used herein may include wireless connection or wireless coupling.

The term “include” or “may include” refers to the existence of a corresponding disclosed function, operation or component that may be used in various embodiments of the disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the disclosure includes any or all combinations of listed words. For example, the expression “A or B” may include A, may include B, or may include both A and B. When describing multiple (two or more) items, if the relationship between multiple items is not explicitly limited, the multiple items may refer to one, many or all of the multiple items. For example, the description of “parameter A includes A1, A2 and A3” may be realized as parameter A includes A1 or A2 or A3, and it may also be realized as parameter A includes at least two of the three parameters A1, A2 and A3.

Unless defined differently, all terms used herein, which include technical terminologies or scientific terminologies, have the same meaning as that understood by a person skilled in the art to which the disclosure belongs. Such terms as those defined in a generally used dictionary are to be interpreted to have the meanings equal to the contextual meanings in the relevant field of art, and are not to be interpreted to have ideal or excessively formal meanings unless clearly defined in the disclosure.

At least some of the functions in the apparatus or electronic device provided in an embodiment of the disclosure may be implemented by an AI model. For example, at least one of a plurality of modules of the apparatus or electronic device may be implemented through the AI model. The functions associated with the AI may be performed through a non-volatile memory, a volatile memory, and a processor.

The processor may include one or more processors. At this time, the one or more processors may be general-purpose processors such as a central processing unit (CPU), an application processor (AP), etc., or a pure graphics processing unit, such as a graphics processing unit (GPU), a visual processing unit (VPU), and/or an AI specialized processor, such as a neural processing unit (NPU).

The one or more processors control the processing of input data according to predefined operating rules or artificial intelligence (AI) models stored in the non-volatile memory and the volatile memory. The predefined operating rules or AI models are provided by training or learning.

Here, providing, by learning, refers to obtaining the predefined operating rules or AI models having a desired characteristic by applying a learning algorithm to a plurality of learning data. The learning may be performed in the apparatus or electronic device itself in which the AI according to the embodiments is performed, and/or may be implemented by a separate server/system.

The AI models may include a plurality of neural network layers. Each layer has a plurality of weight values. Each layer performs the neural network computation by computation between the input data of that layer (e.g., the computation results of the previous layer and/or the input data of the AI models) and the plurality of weight values of the current layer. Examples of neural networks include, but are not limited to, a convolutional neural network (CNN), a deep neural network (DNN), a recurrent neural network (RNN), a restricted Boltzmann machine (RBM), a deep belief network (DBN), a bi-directional recurrent deep neural network (BRDNN), generative adversarial networks (GANs), and deep Q-networks.

The learning algorithm is a method of training a predetermined target apparatus (e.g., a robot) by using a plurality of learning data to enable, allow, or control the target apparatus to make a determination or prediction. Examples of the learning algorithm include, but are not limited to, supervised learning, unsupervised learning, semi-supervised learning, or reinforcement learning.

The method provided in the disclosure may relate to one or more technical fields such as speech, language, image, video, and data intelligence.

In the speech or language field, in accordance with the disclosure, in the method executed by an electronic device, a method for recognizing a user's speech and interpreting the user's intention may receive a speech signal as an analog signal via a capture device (e.g., a microphone) and may use an automatic speech recognition (ASR) model to convert the speech into computer-readable text. The user's intention may be obtained by using the text interpreted and converted through a natural language understanding (NLU) model. The ASR model or the NLU model may be an AI model. The AI model may be processed by an AI-specific processor designed in the hardware structure specified for processing the AI model. The AI model may be obtained by training. Here, “obtained by training” may mean that predefined operating rules or AI models configured to perform desired features (or purposes) are obtained by training a basic AI model with multiple pieces of training data by training algorithms. Language understanding is a technology for recognizing and applying/processing human language/text, for example, including natural language processing, machine translation, dialogue system, question and answer, or speech recognition/synthesis.

In the image or video field, in accordance with the disclosure, in the method executed by an electronic device, a method for recognizing a target object may obtain the output data for recognizing an image or segmentation results in the image by using image data as input data of an AI model. The AI model may be obtained by training. Here, “obtained by training” may mean that predefined operating rules or AI models configured to perform desired features (or purposes) are obtained by training a basic AI model with multiple pieces of training data by training algorithms. The method of the disclosure may relate to the visual understanding field of the AI technology. Visual understanding is a technology for recognizing and processing objects like human vision, including, for example, object recognition, object tracking, image retrieval, human recognition, scene recognition, 3D reconstruction/positioning, or image enhancement.

In the data intelligent processing field, in accordance with the disclosure, in the method executed by an electronic device, a method for inferring or predicting image features, mask features, semantic features, texture features, motion parameters, and the like may use an artificial intelligence model to recommend/perform a prediction by using image data, mask data, or location information. The processor of the electronic device may preprocess data to convert the data into a form suitable for use as an input to the AI model. The AI model may be obtained by training. Here, “obtained by training” may mean that predefined operating rules or AI models configured to perform desired features (or purposes) are obtained by training a basic AI model with multiple pieces of training data by training algorithms. Inference prediction is a technology for performing logic inference and prediction by using the determined information, including, for example, knowledge-based inference, optimized prediction, preference-based planning, or recommendation.

In order to make the objects, technical solutions, and advantages of the disclosure clearer, an embodiment of the disclosure will be described in further detail below in conjunction with the accompanying drawings.

The disclosure may provide a method and a device that may improve the accuracy of image segmentation. The disclosure may provide a video object segmentation method and a device (or an electronic device) that may suppress non-target features and strengthen a target feature in a video.

An embodiment of the disclosure may provide a method performed by an electronic device, the electronic device, a storage medium, and a program product, and the method may also be understood as a Video Object Segmentation (VOS) method that may improve the accuracy of video object segmentation. The method performed by the electronic device may be understood as a method performed by at least one processor.

The technical solution of the embodiment of the disclosure and the technical effects produced by the technical solution of the embodiment of the disclosure will be described by referring to an embodiment. It should be noted that an embodiment may be referred to, learned from or combined with each other, and the same terms, similar characteristics and similar implementation operations in different embodiments are not repeated.

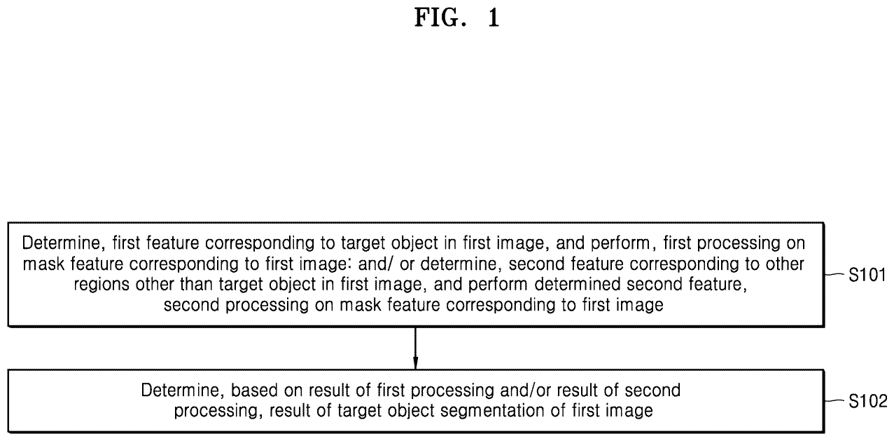

An embodiment of the disclosure may provide a method performed by an electronic device. FIG. 1 illustrates a schematic flowchart of a method performed by an electronic device 4000 according to an embodiment of the disclosure. As shown in FIG. 1, the method may include operations S101 and S102.

In operation S101, the electronic device 4000 may determine a first feature corresponding to a target object in a first image in a video. The electronic device 4000 may determine the first feature based on an image feature of the first image and a first feature corresponding to a target object in at least one second image for which target object segmentation has been performed in the video. The electronic device 4000 may determine the first feature based on the image feature of the first image in the video and mask features corresponding to the target object in the at least one second image. The electronic device 4000 may perform, based on the determined first feature, first processing on a mask feature corresponding to the first image. The electronic device 4000 may determine, based on a second feature corresponding to other regions other than the target object in the at least one second image for which the target object segmentation has been performed in the video and the image feature of the first image, a second feature corresponding to the other regions other than the target object in the first image. The electronic device 4000 may perform, based on the determined second feature, second processing on a mask feature corresponding to the first image. The electronic device 4000 may determine the first feature and perform the first processing, and/or determine the second feature and perform the second processing.

In an embodiment of the disclosure, the electronic device may record the video by user input in real time. The video may be selected by the user in a photo album, or received by the user from a network or other device, and so on, and the embodiment of the disclosure does not require specific limitations on a method of acquiring the video herein.

In the embodiment of the disclosure, the electronic device 4000 may obtain the video by directly recording various objects such as persons, animals, plants, landscapes, buildings, objects, etc., and processing their movement. The electronic device 4000 may obtain the video by synthesizing a plurality of video data or image data, but the embodiment of the disclosure does not require specific limitations on the content and source of the video herein.

In the embodiment of the disclosure, the video may include a sequence of consecutive image frames (which may also be referred to as frames, and in an embodiment may also be replaced with frame images or images), and the embodiment of disclosure does not require specific limitations on the number of image frames of the video herein.

In the embodiment of the disclosure, the electronic device 4000 may specify the target object in any frame image of the video by user input, and may sequentially perform the target object segmentation on other frame images, starting from a frame image from which the target object is specified. For example, the electronic device 4000 may specify the target object in a first frame image, which is a first in order among a plurality of frame images in the video by user input. The electronic device 4000 may process the other frame images frame by frame starting from the first frame image, such that the target object is segmented out from the whole video sequence. For example, the electronic device 4000 may specify the target object in a last frame image in the video by user input. The electronic device 4000 may process the other frame images frame by frame starting from the last frame image in a back-to-front order, such that the target object is segmented out from the whole video sequence. For example, the electronic device 4000 may specify the target object in any middle frame image in the video by user input. The electronic device 4000 may use the middle frame image, from which the target object is specified, as the a first-in-order frame image of a second half of the video, and as a first-in-order frame image of a first half of the video in a reverse order, respectively. The electronic device 4000 may then process both halves of the video frame by frame, starting from the middle frame image from which the target object is specified, thereby segmenting the target object from the whole video sequence. In an embodiment of the disclosure, other processing methods and sequences may also be used, and may be extended by those skilled in the art depending an embodiment, but the embodiment of the disclosure is not limited herein.

In the embodiment of the disclosure, in the process of performing the target object segmentation on the video, an image for which the target object segmentation has been performed is used as a second image, while an image for which the target object segmentation is to be performed is used as the first image, and the first image is auxiliary segmented by using accumulated information of at least one second image. It would be understood that each frame or part of the image in the video may be used as the first image, which becomes the second image after completing the target object segmentation, and a similar process for each frame or part of the image in the video will not be repeated.

The target object may refer to a person, an animal, a plant, a building, an object, etc. in an image, which may be determined by the user's designation (e.g., circling the target object on the image) and other operations, and the embodiment of the disclosure does not require specific limitations on the type of the target object herein or an operation of the user's designation.

In the embodiment of the disclosure, the image feature may refer to a relevant feature characterizing global characteristic or content of the image, such as color, texture, brightness, and the like, but is not limited thereto. The image feature may be used to encode a Key feature by a Key encoder. For example, the image may be input into the Key encoder, and the Key encoder may output the image feature.

In the embodiment of the disclosure, after the electronic device 4000 specifies the target object in any frame image of the video by user input, the electronic device 4000 may obtain a mask corresponding to the target object in the frame image, may obtain a segmentation result of the frame image based on the mask, and may obtain a mask feature corresponding to the target object based on the mask. For example, based on at least one of the frame image, the mask of the target object, or the image feature of the frame image, the electronic device 4000 may extract the mask feature corresponding to the target object in the frame image.

The mask feature may be a relevant feature extracted or improved mainly for the target object. The electronic device 4000 may use the mask feature to encode a Value feature by a Value encoder. For example, the image, the mask of the target object, and the image feature of the image may be input into the Value encoder, and the Value encoder may output the mask feature of the image.

In the embodiment of the disclosure, the mask features corresponding to the first image may include, but are not limited to, mask features corresponding to the target object, mask features corresponding to the other regions, and the like. The mask features may also include features obtained by certain preprocessing of the mask image, such as aligning or calibrating to the first image, noise filtering, etc., and the embodiment of the disclosure is not limited herein.

In the embodiment of the disclosure, the Key feature and the Value feature may be two 1/16 downsampled features, which are obtained by downsampling from the image and the mask of the target object, respectively.

In the embodiment of the disclosure, the electronic device 4000 may determine the first feature corresponding to the target object in the first image based on the first feature corresponding to the target object in the at least one second image for which the target object segmentation has been performed in the video and the image feature of the first image in the video, and/or the electronic device 4000 may determine the second feature corresponding to the other regions other than the target object in the first image based on the second feature corresponding to the other regions other than the target object in the at least one second image for which the target object segmentation has been performed in the video and the image feature of the first image. The other regions other than the target object may include a region where a background and/or other objects, etc., are located. The other objects may refer to other objects that are of the same or similar type (or semantic features) as the target object, and the type or number of the other objects may be one or more. The second feature corresponding to the other regions may include a second feature corresponding to the background and/or a second feature corresponding to the other objects. The number of second features corresponding to the image may be one or more, and those skilled in the art may set the number of second features depending an embodiment, and the embodiment of the disclosure is not limited.

In the embodiment of the disclosure, the extracted first and second features may be viewed as semantic-level and/or instance-level (e.g., texture, pose, action, part affiliation, etc., but not limited thereto) guidance information as compared to pixel-level matching segmentation that may result in mismatches caused by similar pixel objects, such that the results of the pixel matching segmentation may be optimized.

In the embodiment of the disclosure, the electronic device 4000 may use Query features generated by the Query generation module as the first feature and the second feature. For example, the mask feature and the image feature of the corresponding image may be input into the Query generation module, and the Query generation module may output the first feature and the second feature.

In the embodiment of the disclosure, the electronic device 4000 may obtain the first feature corresponding to the first image by updating the first feature based on the first feature corresponding to the at least one second image. The electronic device 4000 may obtain the second feature corresponding to the first image by updating the second feature based on the second feature corresponding to the at least one second image. Then, the first feature and the second feature may be understood as being obtained by updating cumulative Query features based on the information of the at least one second image in real time.

For example, the electronic device 4000 may preliminarily extract the first feature and the second feature for initialization from the mask feature of the second image for which the target object segmentation is first performed. The first feature and the second feature may be defined according to a semantic similarity to the target object. For the other frame images, the electronic device 4000 may perform sequentially updating frame-by-frame to form an accumulation of corresponding region information to locate possible new objects to obtain the first and second features corresponding to the first image, which in turn may be used as guidance (or basis) to optimize the results of the target object segmentation of the first image.

In the embodiment of the disclosure, the number and type of the first feature and the second feature may be optionally provided. In an embodiment, the electronic device 4000 may accumulate the target object and related semantics in a historical frame image, and may use these semantics to refine pixel-level features in a current frame image into target-aware features, thereby accurately encoding the following three kinds of query features.

(1) Query Features of the Region where the Target Object is Located.

The electronic device 4000 may use these query features to accumulate semantic and instance information (e.g., texture, pose, action, part affiliation, etc.) of the target object in history frames, which may be simply referred to as a target query feature or a target Query, and the electronic device 4000 may use these query features as the first feature.

(2) Query Features of the Region where the Background is Located.

The region where the background is located may be a region that is substantially (or excessively) dissimilar to the target object, and the query features of the region where the background is located may be used to accumulate semantic and instance information of the background in history frames, which may be simply referred to as a background query feature or a background Query, and the electronic device 4000 may use these query features as the second feature.

(3) Query Features of the Region where the Other Objects are Located.

The region where the other objects are located may be a region which is similar to semantic features of the target object but not similar to the background, and the query features of the region where the other objects are located may be used to accumulate semantic and instance information of the other objects in history frames, which may be simply referred to as other object query features or other query features or others Query, the number of which may be one or more, and the electronic device 4000 may also use these query features as the second feature.

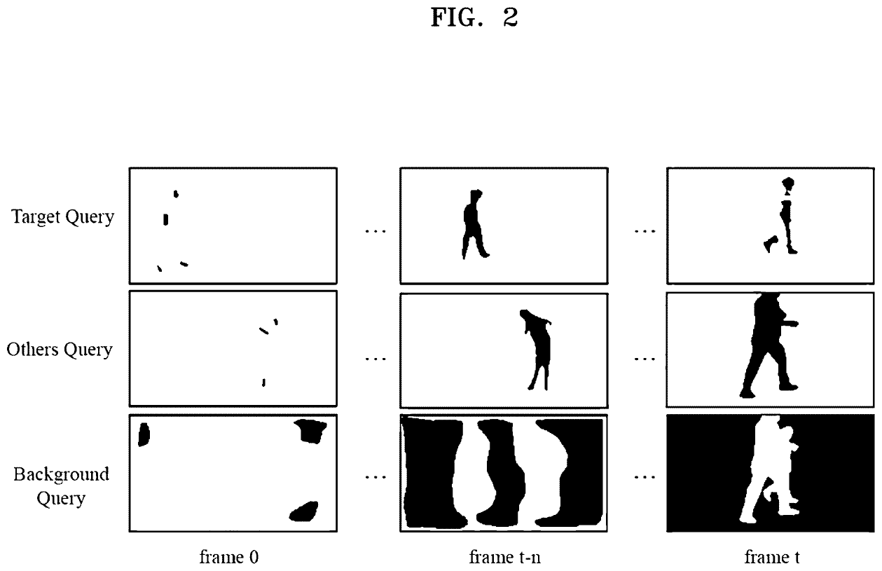

FIG. 2 illustrates a schematic diagram of three Queries according to an embodiment of the disclosure. The three Queries may include the target Query, the background Query, and the others Query. The target Query may represent the accumulation of target object information in the historical information. The background Query may represent the accumulation of background information in the historical information. The other Query may represent the accumulation of other object information in the historical information. Taking the user specifying the target object in frame 0 as an example, at an initial stage, the Query feature may have a weak ability to characterize a particular object or its semantic information, but as the Query feature is updated frame by frame, a characterization ability of the Query feature becomes stronger and stronger (e.g., frame t), and may be sufficient to characterize objects or the semantic information that they respectively represent.

In the embodiment of the disclosure, the first processing may also be understood as enhancement processing and the second processing may be understood as suppression processing. For example, the background Query and the others Query may be used as guidance (or basis) to suppress semantic information of the “background” and “other objects”, and the target Query may be used as guidance to strengthen features of the target object.

In operation S102, the electronic device 4000 may determine, based on a result of the first processing and/or a result of the second processing, a result of the target object segmentation of the first image.

In the embodiment of the disclosure, the electronic device 4000 may optimize each frame of the first image (e.g., suppressing features of the other regions and strengthening features of the target object) and then the optimized frames may go through a decoder to obtain a segmentation result of the target object in the first image, such as a prediction result Mask.

An embodiment of the disclosure provides a method performed by an electronic device 4000 for segmenting out a target object from an entire video including the target object, where the result of target object segmentation of the video may be optimized by accumulating information corresponding to at least one second image into a first feature and a second feature, and using the first feature and the second feature as guidance to process a mask feature corresponding to the first image, such that the target object may be predicted with higher accuracy.

Hereinafter, for ease of description, the above operation of “perform, based on the determined first feature, first processing on a mask feature corresponding to the first image” is labeled as operation SA, and the above operation of “perform, based on the determined second feature, second processing on a mask feature corresponding to the first image” is labeled as operation SB.

In the embodiment of the disclosure, operation SB may be performed by a semantic suppressor module 300 (the semantic suppressor module 300 may be included in the electronic device 4000 or may be included in a processor that is either independent of or not included in the electronic device 4000) that suppresses non-target semantics (such as “other objects” and “background”) using the second feature (such as the others Query and the background Query) as guidance to optimize inputs from pixel-level features to semantic-level features and may include:
Operation SB1: fuse the determined second feature with the mask feature corresponding to the first image to obtain a third feature, where the third feature characterizes features corresponding to the other regions existing in the mask feature;
The process of fusing the second feature with the mask feature corresponding to the first image to obtain the third feature may be understood as determining non-object features, such as a residual background or features of the other objects, in the mask feature corresponding to the first image, based on the mask feature corresponding to the first image, and the third feature may also be understood as features other than the features of the target object included in the mask feature.

The process of fusing may include, but is not limited to, element-by-element addition and/or element-by-element multiplication, and the like. In the case of including one second feature, for example, the determined second feature may be multiplied element-by-element with the mask feature corresponding to the first image to obtain the third feature. In the case of including two second features, for example, the determined two second features may be multiplied element-by-element with the mask feature corresponding to the first image respectively, and the result of element-by-element multiplication may be summed element-by-element. In an embodiment the determined two second features may be added element-by-element, and then the result of element-by-element addition may be multiplied element-by-element with the mask feature corresponding to the first image, and so on. The case of more than two second features may be analogized, and will not be discussed for brevity of description.

Operation SB2: remove the third feature from the mask feature corresponding to the first image.

The removal process may include but is not limited to element-by-element subtraction, and the like.

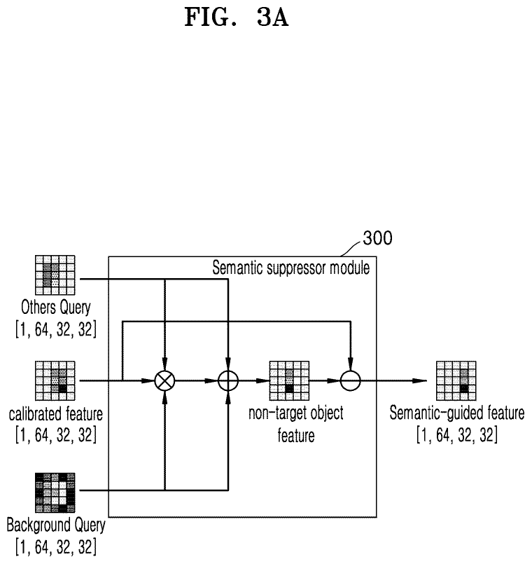

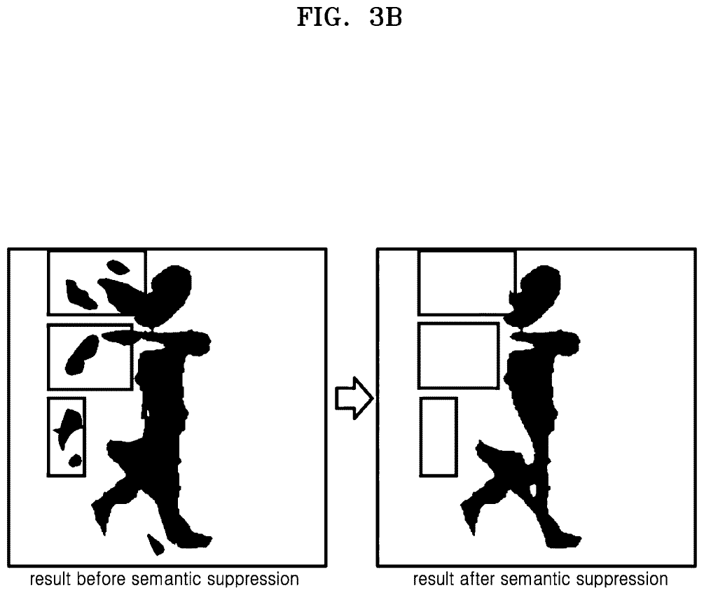

FIG. 3A illustrates a schematic diagram of a processing method of a semantic suppressor module 300 according to an embodiment of the disclosure. As shown in FIG. 3A, an example implementation process may be as follows.

(1) Element-by-element multiplication and element-by-element addition of the mask feature corresponding to the first image (e.g., a mask feature after calibrating to the first image) with the others Query and the background Query are performed, respectively, in sequence, to obtain a non-target object feature (e.g., the third feature), which may also be referred to as a non-target feature, where the non-target feature characterizes a region other than the target object in the mask feature.

(2) The mask feature corresponding to the first image may be utilized to perform element-by-element subtraction with the non-target object feature, thereby suppressing the non-target object region and strengthening the target object feature, and the obtained feature may be referred to as a semantic-guided feature.

FIG. 3B illustrates a schematic diagram of a comparison of effects before and after semantic suppression of a non-target object using the semantic suppressor module 300 according to an embodiment of the disclosure. As shown in FIG. 3B, a mask may correspond to the target object “Person A” in the image where Person A walks between Person B and a wall, and a portion of which the texture is similar to the target object in non-target object regions (such as the background “wall” or other objects “Person B”, etc.) within three boxes in FIG. 3B may be easy to be erroneously detected as the mask of the target object. It may be seen that the non-target object regions in the three boxes may be effectively suppressed after the semantic suppression (or a semantic guidance) to guarantee the accuracy of the target object features.

In the embodiment of the disclosure, operation SA may be performed by a target attention module 400 (the target attention module 400 may be included in the electronic device 4000 or may be included in a processor that is either independent of or not included in the electronic device 4000) that utilizes the first feature (e.g., the target Query) as guidance to refine semantic-guided functions, and to strengthen the responses of the target object by merging different target object features, and similarly optimize the inputs from pixel-level features to semantic-level features. The operation SA may be performed based on the first feature (e.g., the target Query) by the target attention module 400. The operation SA may include operations SA1 and SA2:
Operation SA1: determine an affinity between the determined first feature and the mask feature corresponding to the first image, to obtain first affinity information.

The first affinity information may be represented as a similarity matrix (which may also be referred to as an affinity matrix or a similar matrix), but is not limited thereto.

In the embodiment of the disclosure, a numerical value in the first affinity information may indicate a degree of identity of pixels in relevant features of the two target objects with respect to a semantic response of the target object, and the higher the degree of identity is, the higher the probability of belonging to the target object is.
Operation SA2: process the mask feature corresponding to the first image based on the first affinity information.

A processing method for operation SA2 may be fusing the first affinity information with the mask feature corresponding to the first image, but is not limited thereto.

The fusion method may use a matrix multiplication or the like, but is not limited thereto.

Further, the determined first feature may also be updated based on the first affinity information. For example, the first affinity information and the determined first feature may be fused to obtain the updated first feature, which is used to process the mask feature corresponding to at least one image for which the target object segmentation has not been performed in the video.

At least one image for which the target object segmentation has not been performed in the video may be determined based on a processing sequence and the progress of the image frames. For example, if the electronic device 4000 specifies the target object in the first frame image by user input, the second frame image and the third frame image may be processed sequentially from the first frame image. By analogy, when the third frame image is processed, both the first frame image and the second frame image may be understood as the second image. The second frame image may also be referred to as a neighboring processed second image, and the third frame image may be understood as the first image. The fourth frame image, the fifth frame image, and so on may be at least one image for which the target object segmentation has not been performed in the video and may also be referred to as adjacent unprocessed images. The other processing progresses and sequences may be derived in an analogous manner, which will not be repeated herein.

Therefore, in the embodiment of the disclosure, the first feature (e.g., a query feature corresponding to the target object) may be updated frame by frame with more accurate semantic-guided information, such that characterization ability of the first feature may become stronger and stronger, and may be sufficient to characterize the information of the region where the target object is located.

The fusion method may also use a matrix multiplication, and the like, but is not limited thereto.

It is to be noted that there is no limitation on the execution order of the above operations SA and SB. For example, operation SA may be performed before operation SB, or operation SB may be performed before operation SA, or operations SA and SB may be performed at the same time, and the like. Accordingly, if operation SA is performed before operation SB, the mask feature corresponding to the first image in the SB1 may be replaced with an output result of operation SA2, and if operation SB is performed before operation SA, the mask feature corresponding to the first image in operation SA1 may be replaced with an output result of operation SB2, and if operations SA and SB are performed at the same time, the output results of operations SA2 and SB2 may be fused.

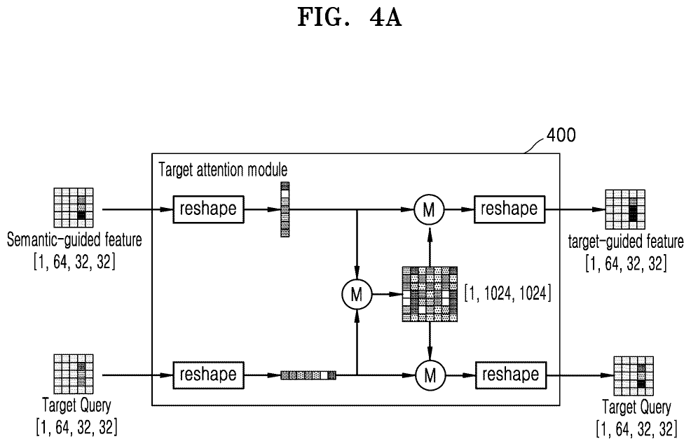

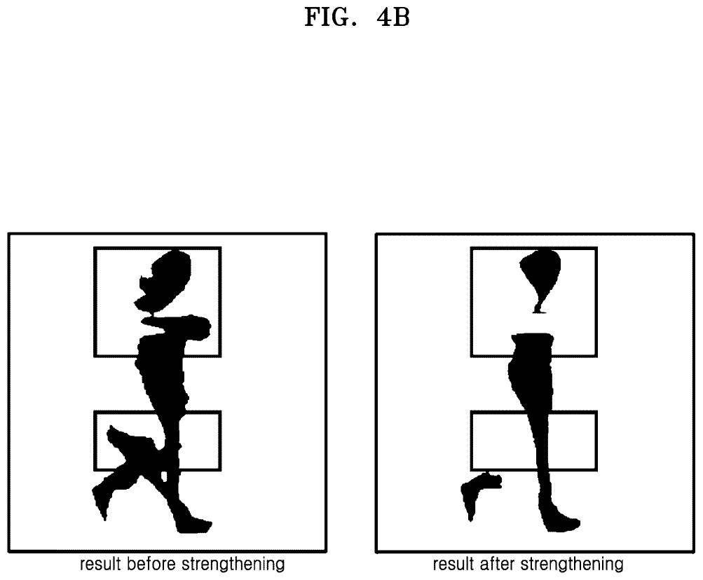

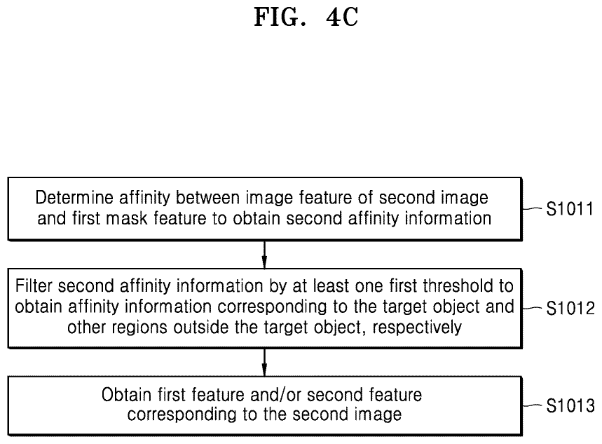

FIG. 4A illustrates a schematic diagram of a processing method of a target attention module 400 according to an embodiment of the disclosure. As shown in FIG. 4a, taking the operation SA being performed after the operation SB, an implementation process may be as follows.

(1) The target attention module 400 may utilize the semantic-guided features and the target Query output from the operation SB2 to calculate a similarity matrix, and numerical values in the similarity matrix may indicate responses of feature pixels to the target semantics. The semantic-guided features and the target Query may be reshaped separately, and the reshaped semantic-guided features and the reshaped target Query may be matrix multiplied to obtain the similarity matrix (the first affinity information).

(2) The target attention module 400 may perform matrix multiplication between the similarity matrix and the semantic-guided features to optimize the semantic-guided features for further strengthening of the target object features. After performing the matrix multiplication on the similarity matrix and the reshaped semantic-guided features, the features obtained by reshaping back to the original size of the semantic-guided features may be called target-guided features.

(3) The target attention module 400 may perform matrix multiplication between the similarity matrix and the target Query to update the target Query. After performing the matrix multiplication on the similarity matrix and the reshaped target Query, the updated target Query may be obtained by reshaping back to the original size of the target Query.

FIG. 4b illustrates a schematic diagram of a comparison of effects before and after strengthening a target feature using the target attention module 400 according to an embodiment of the disclosure. As shown in FIG. 4b, a mask may correspond to the target object “Person A” in the image where Person A walks between Person B and a wall, and a portion of which the texture is similar to the target object in non-target object regions (such as the other object “Person B”, etc.) within two boxes in FIG. 4b and the target object is occluded may be easy to be erroneously detected as the target object. It may be seen that the non-target object regions in the two boxes may be effectively strengthened. For example, a portion which is occluded may be adjusted and the overall features may be closer to real forms to guarantee the accuracy of the target object features.

In the embodiment of the disclosure, the process of determining the first feature and/or the second feature corresponding to the first image in operation S101 may be performed by a Query updater module 500 (the Query updater module 500 may be included in the electronic device 4000 or may be included in a processor that is either independent of or not included in the electronic device 4000) that may accumulate information contained in each image frame into respective Query features. In an embodiment, determining the first feature and/or the second feature corresponding to the first image may include updating the first feature and/or the second feature corresponding to the at least one second image based on the image feature of the first image, to obtain the first feature and/or the second feature corresponding to the first image.

The first feature and/or the second feature corresponding to the at least one second image may be determined by the following operations: for at least a portion of the at least one second image, determining a first mask feature corresponding to the second image, and extracting the first feature and/or the second feature corresponding to the second image from the first mask feature; and for each second image except the portion of the at least one second image, updating, based on an image feature of the second image, the first feature and/or the second feature corresponding to the at least one second image for which the target object segmentation has been performed before the second image, to obtain the first feature and/or the second feature corresponding to the second image.

That is, the first feature and/or the second feature corresponding to one image or some images in the video may be extracted from the first mask feature corresponding to the image, and the first feature and/or the second feature corresponding to another image or some images may be obtained by updating the first feature and/or the second feature corresponding to other images. In practical applications, those skilled in the art may set the image in which the first feature and/or the second feature are directly extracted from the first mask features depending an embodiment, and the embodiment of the disclosure is not limited herein. For example, the image in which the first feature and/or the second feature are directly extracted from the first mask feature may include a second image of the at least one second image on which the target object segmentation has been performed first, which, for convenience of description, will be referred to below as a third image.

As an example, the process of determining the first feature and/or the second feature may include: determining a first mask feature corresponding to the third image, and extracting the first feature and/or the second feature corresponding to the third image from the first mask feature; and for each second image except the third image in the at least one second image, updating, based on an image feature of a certain second image, the first feature and/or the second feature corresponding to the at least one second image for which the target object segmentation has been performed before the certain second image, to obtain the first feature and/or the second feature corresponding to the certain second image.

For the second image on which the target object segmentation has been performed first (e.g., the third image in the at least one second image) in which the first feature and/or the second feature are directly extracted from the first mask feature, the first mask feature may be extracted based on at least one of the second image and its first mask feature, as well as the image feature of the second image. For example, the second image, the first mask feature, and the image feature of the second image may be input into the Query generation module 500, which may output the first feature and the second feature corresponding to the second image (e.g., the third image in the at least one second image).

The first feature and/or the second feature corresponding to the at least one second image for which the target object segmentation has been previously performed may be sequentially updated, starting from the second image (e.g., the third image) in which the target object segmentation has been performed first.

The update of the first feature and/or the second feature of a certain frame may make reference to image features of the certain frame to accumulate information contained in the certain frame into the first feature and/or the second feature.

If an image feature has already been extracted historically, that extracted image feature may be used directly, or the image feature may be re-extracted, for example, by passing each of the second image and the first image through the Key encoder, respectively, to obtain the corresponding image features, and the embodiment of the disclosure is not limited herein.

In the embodiment of the disclosure the first feature and the second feature may be updated on a frame-by-frame basis to guarantee a validity of the first feature and the second feature (e.g., the query features). Then, the first feature and the second feature may be understood as an accumulation of corresponding object or region information in multi-frame images. At an initial stage, the first feature and the second feature (e.g., the query features) may have weak abilities to characterize the corresponding object or region or semantic information thereof, but as the query features are updated frame by frame, characterization abilities of the first feature and the second feature become stronger and stronger, and may be sufficient to characterize the object or region or semantic information thereof that the object or region represents.

In the embodiment of the disclosure, adding semantic-level and/or instance-level information (e.g., the first feature and/or the second feature, such as high-level multi-frame image accumulation information) as guidance may optimize the mask feature corresponding to the first image at a semantic level, thereby improving the accuracy of the mask feature corresponding to the first image.

In the embodiment of the disclosure, FIG. 4C shows the above operation of extracting the first feature and/or the second feature corresponding to the second image (e.g., the third image) from the first mask feature. FIG. 4C illustrates an operation of extracting the first feature and/or the second feature corresponding to the second image (e.g., the third image) from the first mask feature according to an embodiment of the disclosure. The operation of extracting the first feature and/or the second feature may include:

Operation S1011 of FIG. 4C: determine an affinity between the image feature of the second image and the first mask feature, to obtain second affinity information.

If the image feature of the at least one second image has already been extracted historically, the image feature that has been extracted may be used directly, or the image feature may be re-extracted, for example, by passing the at least one second image through the Key encoder, to obtain the corresponding image features, and the embodiment of the disclosure is not limited herein.

The second affinity information may be represented as a similarity matrix.

In the embodiment of the disclosure, a numerical value in the second affinity information may indicate a response of each pixel in the image feature to the target object, and a larger value may indicate a higher probability of belonging to the target object.

Operation S1012 of FIG. 4C: filter the second affinity information by at least one first threshold to obtain affinity information corresponding to the target object and other regions outside the target object, respectively.

Those skilled in the art may set a number of the at least one first threshold and a specific value thereof depending an embodiment, and the embodiment of the disclosure is not limited herein. As an example, it is assumed that two first thresholds a and b are set, and a is less than b, then 3 intervals (<a, a˜b, >b, etc.) formed by the two first thresholds may be filtered out from the second affinity information into 3 sets of affinity information corresponding to 3 regions, respectively, and other number of the at least one first threshold may be reasoned by analogy. As an example, it is assumed that two sets of the first thresholds a1˜a2 and b1˜b2 are set, 2 sets of affinity information may be filtered out from the second affinity information (the remaining affinity information may be processed in other ways, such as being discarded, or as a third set), and the first thresholds for the other number of sets may be reasoned by analogy. Those skilled in the art may set the filtering method depending an embodiment, and the embodiment of the disclosure is not limited herein.

Operation S1013 of FIG. 4C: obtain, based on the affinity information corresponding to the target object and the other regions outside the target object, respectively, and the image feature of the second image, the first feature and/or the second feature corresponding to the second image.

The affinity information corresponding to the target object and the other regions outside the target object, respectively, and the image feature of the second image may be fused, to obtain the first feature and/or the second feature corresponding to the second image.

The fusion method may use a matrix multiplication or the like, but is not limited thereto.

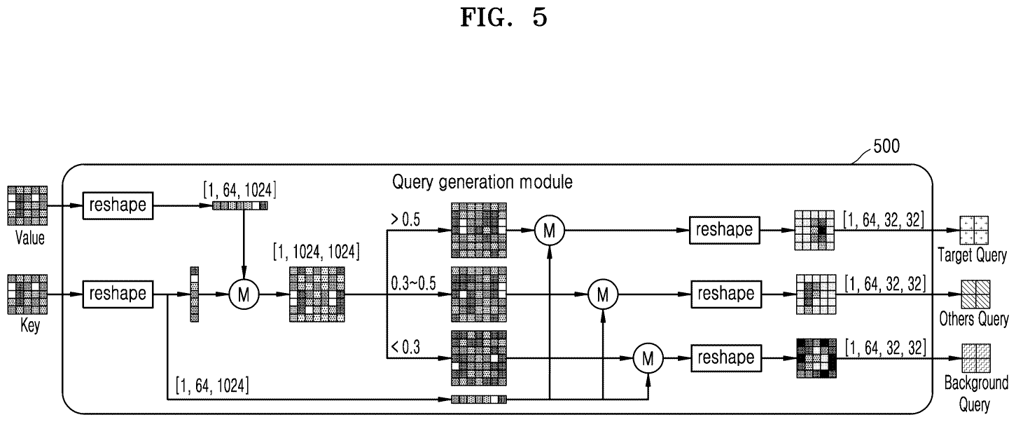

FIG. 5 illustrates a schematic diagram of a processing method of a Query generation module 500 according to an embodiment of the disclosure, which may include operations as follows.

(1) Computing a similarity matrix (the second affinity information) of the image feature Key and the mask feature Value, and reshaping the image feature Key and the mask feature Value separately, for example, with a reshaped size of [1,64,1024], and performing a matrix multiplication on the reshaped mask feature Value and the reshaped image feature Key, to obtain the similarity matrix of the image feature Key and the mask feature Value. Numerical values in the similarity matrix may indicate a response of each pixel in the image feature to the target object, and a larger value may indicate a higher probability of belonging to the target object.

(2) Filtering out a target object matrix, other object matrix and a background matrix respectively by different thresholds, e.g., filtering out the target object matrix having a threshold larger than 0.5, the other object matrix having a threshold between 0.3 and 0.5, and the background matrix having a threshold smaller than 0.3 from the similarity matrix.

(3) Using the image feature Key to perform matrix multiplication with the target object matrix, the other object matrix, and the background matrix, respectively, to obtain the target Query, the others Query, and the background Query. The reshaped image feature Key may be reshaped back to a size of [1,64,32,32] after matrix multiplication with the target object matrix, the other object matrix, and the background matrix, respectively, to obtain the target Query, the others Query, and the background Query.

The Query generation module 500 may accurately encode different semantic information into the target Query, background Query and others Query, and suppress the semantic information of the “background” and “other objects” by using the background Query and others Query as guidance through the Query attention module, and enhance the features of target objects by using the target Query, thus optimizing the mask features.

Those skilled in the art should be able to understand that the thresholds and sizes in the above examples are only schematic descriptions, and do not constitute limitations on the embodiment of the disclosure, and appropriate changes based on the examples may also be applicable to the disclosure, and therefore should be included in the scope of protection of the disclosure.

In the embodiment of the disclosure, the process of updating, based on the image feature of the first image, the first feature and/or the second feature corresponding to the at least one second image, to obtain the first feature and/or the second feature corresponding to the first image may include: determining an affinity between the image feature of the first image and the first feature corresponding to the at least one second image, to obtain third affinity information; determining an affinity between the image feature of the first image and the second feature corresponding to the at least one second image, to obtain fourth affinity information; normalizing the third affinity information and the fourth affinity information; obtaining the first feature corresponding to the first image based on the normalized third affinity information and the first feature corresponding to the at least one second image; and obtaining the second feature corresponding to the first image based on the normalized fourth affinity information and the second feature corresponding to the at least one second image.

It would be understood that the number of the fourth affinity information corresponds to the number of the second feature. For example, the background Query and the others Query may correspond to different fourth affinity information.

The third affinity information and the fourth affinity information may be represented as a similarity matrix, but are not limited thereto.

In the embodiment of the disclosure, numerical values in the third affinity information and the fourth affinity information may indicate the responses of pixels in the image feature to different query features, and the larger the value is, the higher the probability that the pixel may belong to a particular query feature semantics may be.

In the embodiment of the disclosure, normalization of the third affinity information and the fourth affinity information may be performed by scaling that pixel of the third affinity information and the (one or more) fourth affinity information into a specific interval proportionally for each pixel. For example, a sum of a piece of third affinity information and a plurality of pieces of fourth affinity information for that pixel is 1, etc., but not limited thereto. The normalization operation may prevent a pixel from being highly responsive to a plurality of Query features at the same time, thereby helping to strengthen the true semantics to which the pixel belongs, and suppressing the response to other erroneous Query features.

The normalized third affinity information and the first feature corresponding to the at least one second image may be fused to obtain the first feature corresponding to the first image, and the normalized fourth affinity information and the second feature corresponding to the at least one second image may be fused to obtain the second feature corresponding to the first image, for representing a set of historical features including information from the beginning to the first image (the query features before updating include information from the beginning to the last second image for which the target object segmentation was performed).

The fusion method may use a matrix multiplication or the like, but is not limited thereto.

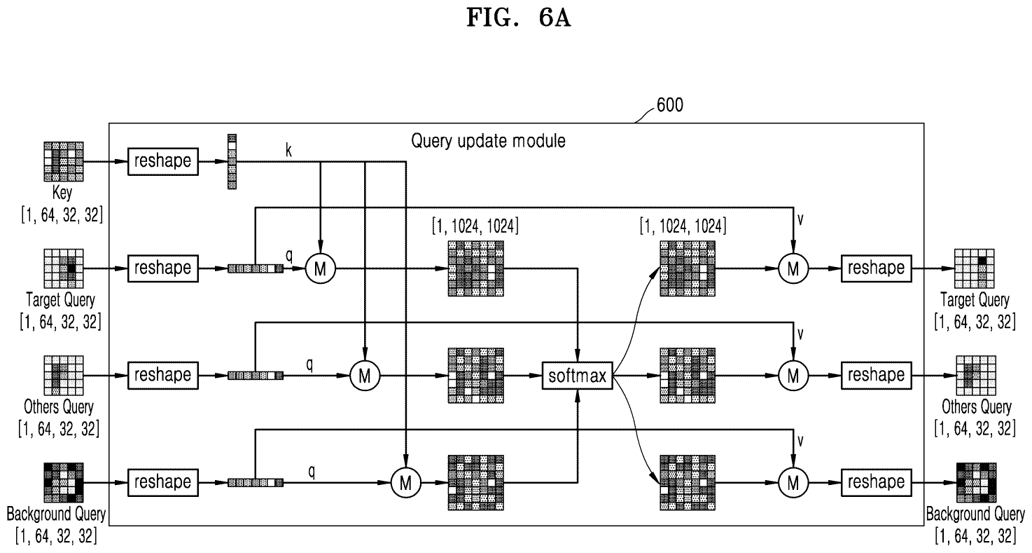

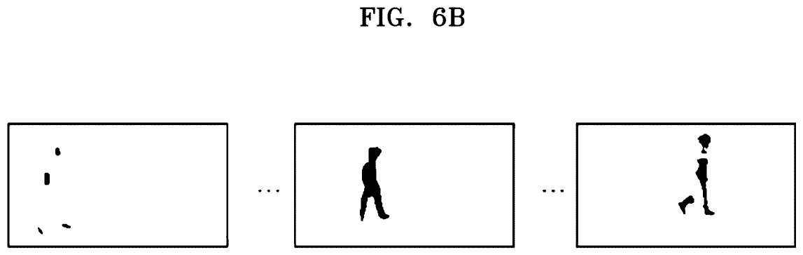

FIG. 6A illustrates a schematic diagram of a processing method of a Query updater module 600 according to an embodiment of the disclosure. As shown in FIG. 6A, taking the above three kinds of Queries (e.g., target Query, others Query, and background Query) as an example, an implementation process may be as follows.

(1) Use the image feature Key to compute a similarity matrix with the target Query, the others Query, and the background Query, respectively, and numerical values in the similarity matrix may indicate the responses of pixels in the image feature to different Queries, and a larger value may indicate a larger probability that the pixel belongs to a semantic category corresponding to the corresponding Query. The image feature Key and the three Queries (e.g., target Query, others Query, and background Query) may be reshaped separately, and the reshaped image feature Key may be matrix multiplied with the reshaped three Queries respectively, to obtain three similarity matrices (the third affinity information).

(2) The three similarity matrices may be normalized at each pixel position by softmax to avoid the same feature pixel having a high response to multiple Queries.

(3) Perform matrix multiplication respectively with its own Query using the normalized similarity matrix. After performing the matrix multiplication respectively with the reshaped own Query using the normalized similarity matrix, the updated three Queries may be obtained by reshaping back to the original Query size.

FIG. 6B illustrates a schematic diagram of a Query accumulation effect according to an embodiment of the disclosure. For example, taking the target Query as an example, a schematic diagram of the Query accumulation effect may be shown in FIG. 6B. Taking the first image to be frame 0 as an example, it may be seen that, as the Query updater module 600 updates the target Query frame by frame to accumulate various information (e.g., pose, motion, part affiliation, etc.) into the target Query frame by frame, the target Query's ability to represent the target object may be improved. At an initial stage, the ability to represent the target object is weak, and only a small portion of the region of the target object may respond to the target Query, and as more information is accumulated, the target Query may represent a more complete target object, until eventually the target object may be accurately characterized.

In the embodiment of the disclosure, the mask feature corresponding to the first image may be a mask feature calibrated (or aligned) to the first image. As an example, for the third image, the similarity matrix may be obtained by computing an affinity between the image feature (e.g., Key feature) of the third image and the image feature (e.g., Key feature) of the first image. Since the image features contain appearance-level information, the similarity matrix computed according to the image features may represent an affinity between pixels, and the pixels with higher affinity may have higher values in the similarity matrix, and the similarity matrix may be aligned with the mask feature (e.g., Value feature) of the third image, e.g., using matrix multiplication, to obtain the mask feature calibrated to the first image, and since the mask feature calibrated to the first image is computed based on a pixel affinity, pixel-level information may be contained. Therefore, it may also be referred to as a pixel matching result. It would be understood that the calibration of the mask feature corresponding to the first image is not limited to the above-described methods, and other calibration methods may also be used.

In the embodiment of the disclosure, a memory update mechanism is provided to obtain (calibrate) the mask feature corresponding to the first image. In an embodiment, the method may further include: determining a first image feature that is most similar to the image feature of the first image among at least one target image feature, and fifth affinity information between the most similar first image feature and the first image; and obtaining the mask feature corresponding to the first image based on a mask feature corresponding to the first image feature and the fifth affinity information.

The target image feature refers to an image feature of a stored image, and a mask feature corresponding to the image feature refers to a mask feature corresponding to the stored image. The at least one target image feature may be an image feature of the at least a portion of the at least one second image.

If an image feature has already been extracted historically, that image feature that has been extracted may be used directly, or the image feature may be re-extracted, e.g., by passing the corresponding image through the Key encoder, to obtain an image feature thereof, and the embodiment of the disclosure is not limited herein.

The corresponding mask feature of the first image feature and the fifth affinity information may be fused, whereby the mask feature corresponding to the first image is obtained based on the fusion result.

The memory module 800 may be used to store the required image feature and mask feature (for ease of description, the image feature and the mask feature may be collectively referred to as reference features).

In an embodiment, reference features corresponding to each second image of the video may be stored, thus the target image features may be the reference features corresponding to each second image. In an embodiment, reference features corresponding to some of the second images may be stored according to certain storage rules, thus the target image features may be the reference features corresponding to some of the second images. In an embodiment, reference features corresponding to some of the second images may be merged and stored or clustered and stored, to save storage and computational resources and increase processing speed, and those skilled in the art may set the storage method depending an embodiment, and the embodiment of the disclosure is not limited herein.

In the embodiment of the disclosure, the most similar first image feature may also be an image feature that has the highest affinity between the stored image features and the image features of the first image, and the fifth affinity information may also be the affinity information between that image feature and the image feature of the first image.

The fifth affinity information may be represented as a similarity matrix, but is not limited thereto.

In the embodiment of the disclosure, in the process of matching the target object, a validity of reference features may be guaranteed by selecting a feature with the highest affinity to the current frame (the first image) as a reference feature.

In the embodiment of the disclosure, the fusion method may use matrix multiplication, or the like, but is not limited thereto.

At an inference stage, in addition to selecting the first image feature and corresponding mask feature, the second image feature and corresponding mask feature of a neighboring processed frame containing the target object may be combined to make a target object matching, to obtain a real-time video object segmentation result with good performance.

In an embodiment, obtaining the mask feature corresponding to the first image based on the corresponding mask feature of the first image feature and the fifth affinity information may include: determining a second image feature corresponding to a last second image for which the target object segmentation has been performed and which contains the target object in the at least one second image, and sixth affinity information between the second image feature and the first image; and obtaining the mask feature corresponding to the first image based on the mask feature corresponding to the first image feature, the fifth affinity information, a mask feature corresponding to the second image feature, and the sixth affinity information.

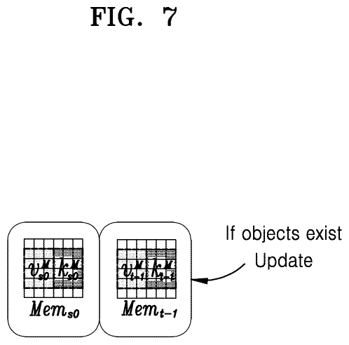

FIG. 7 illustrates a schematic diagram of a processing method using a memory module according to an embodiment of the disclosure. As an example, FIG. 7 shows a schematic diagram using a memory module (which may also be referred to as a first memory module) by using two frames of reference features as a reference for target object matching, including past reference features Memₛ₀ (including mask features and image features

$${v}_{s 0}^{M}$$

and image features

$${k}_{s 0}^{M} )$$

and proximity reference features Memₜ₋₁ (including mask features

$${v}_{t - 1}^{M}$$

and image features

$${k}_{t - 1}^{M} ) ,$$

where neighboring reference features are reference features (e.g., the second image feature and corresponding mask feature) of the processed frame containing the target object that is closest to the current frame (the first image), the neighboring reference feature is a reference feature of a frame that is more similar to the current frame and takes into account the presence of the mask. During the process of frame-by-frame inference, whenever the target object is present in an image frame, the corresponding reference feature may be updated to the neighboring reference feature to avoid injecting noise into the memory module. The past reference feature may be a reference feature of a processed frame that is far away from the current frame but helpful to the current frame, for example, the reference feature that has the highest affinity among the reference features of the processed frame may be used as the past reference feature (such as the first image feature and corresponding mask feature), and a reference effect of the past reference feature described above may be more effective compared to a reference feature based on a fixed reference to the first image in the case of a long video or a video that greatly varies, using the memory module to preserve two reference feature locations.

The image features of the current frame image may be computed with the first image feature and the second image feature to compute the affinity, respectively, obtain two affinity computation results (the fifth affinity information and the sixth affinity information), merge these two affinity computation results, merge the corresponding mask features, and fuse the merged mask features and the merged affinity computation results (e.g., by using matrix multiplication, etc., but not limited thereto), and the mask feature calibrated to the current frame may be obtained based on the fusion result.

In the embodiment of the disclosure, with respect to the memory update mechanism, a reference feature update mechanism may also be provided, whereby the reference features are updated frame by frame to guarantee the validity of reference features, for example, by comparing a degree of change between the target Query of the current frame and the target Query of the previous frame to determine whether to update the reference features of the current frame to the reference features of the processed frames of the image to be processed in a past memory module (which is responsible for storing the reference features of the processed frames of the image to be processed, and is also called a second memory module), to guarantee that only the frame features with large and meaningful differences are preserved in the past memory module. The degree of change of the target Query may be derived by similarity computation.

In an embodiment, an affinity between the first feature corresponding to the second image and the first feature corresponding to the at least one second image for which the target object segmentation has been performed before the second image may be determined for each second image of the at least one second image, to obtain seventh affinity information, and when the seventh affinity information is greater than a second threshold, the image feature of the second image is used as a target image feature, and the target image feature and its corresponding mask feature may be stored, such as being updated into the past memory module, to guarantee that only the reference features of frames with large and meaningful differences are preserved in the past memory module.

An affinity between the first feature corresponding to the second image and the first feature corresponding to the at least one second image for which the target object segmentation has been performed before the second image may be determined to obtain at least one seventh affinity information. In an embodiment, an affinity between the first feature corresponding to the second image and the at least one second image for which the target object segmentation has been performed before the second image may be determined and fused to at least one affinity result to obtain the seventh affinity information. In an embodiment, the first feature corresponding to the at least one second image for which target object segmentation has been performed before the second image may also be fused, and an affinity between the first feature corresponding to the second image and the fused first feature may be determined to obtain the seventh affinity information, and the embodiment of the disclosure is not limited herein.

For example, the seventh affinity information sim may be computed as follows.

$$sim = \frac{{Q}_{t - 1}^{Target} \cdot {Q}_{t}^{Target}}{‖ {Q}_{t - 1}^{Target} ‖ ‖ {Q}_{t}^{Target} ‖} ,$$

where,

$${Q}_{i}^{Target}$$

denotes the target Query of the ith frame, and when the target Query of the current frame greatly changes from the target Query of the previous frame and sim is greater than a predetermined second threshold, the reference features of the current frame may be updated to the past memory module, and on the contrary, when sim is less than the second threshold, the reference features of the current frame may be discarded.

In the embodiment of the disclosure, with respect to the reference feature update mechanism, there may also be provided an embodiment in which clusters of a limited number of historical features may be preserved and these cluster features may be continuously updated during processing of subsequent frames to guarantee the validity of reference features.

An embodiment of the disclosure may further include, before storing the target image features and their corresponding mask features: determining a third image feature that is most similar to the image feature of the second image among the stored target image features, when the number of stored image features reaches a predetermined number.

In the embodiment of the disclosure, based on a limited random-access memory (RAM) space on a mobile device and the consideration of the speed impact of the model, a predetermined number of reference feature locations may be preserved in the past memory module 810. In practical applications, those skilled in the art may set the value (such as 5, etc.) of the predetermined number depending an embodiment, and the embodiment of the disclosure is not limited herein.

In the embodiment of the disclosure, the most similar third image feature may also be an image feature with the highest affinity between the stored predetermined number of image features and the image features of the current frame image.

Then, storing the target image features and corresponding mask feature thereof may include: fusing the third image feature and the corresponding mask feature, with the image feature of the second image and corresponding mask feature; and updating the stored third image feature and corresponding mask feature to the fused image feature and corresponding mask feature.

For the embodiment of the disclosure, the process may realize the clustering of reference features or the updating of clustered reference features, to guarantee the validity of such reference features.

Since a predetermined number of reference feature locations may be stored in the past memory module, the fused image features and mask features may be stored by replacing the third image features and corresponding mask features when the past memory module 810 is full.

When the number of stored image features does not reach the predetermined number, the image features and mask features of the second image may be continuously stored in the past memory module.

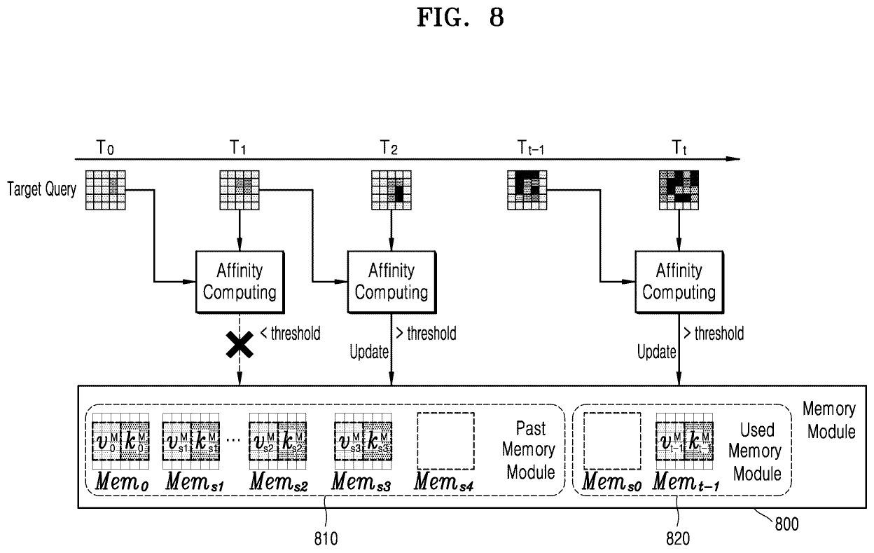

FIG. 8 illustrates a schematic diagram of a reference feature update mechanism according to an example embodiment of the disclosure. In FIG. 8, based on the embodiment, the memory module 800 may include a past memory module 810 and a used memory module 820, and an example implementation process may be as follows:

By comparing the degree of change of the target Query of each frame with the target Query of the previous frame, it may be determined whether to update the current frame features into the past memory module 810, thereby guaranteeing that only the reference features of the frames with large and meaningful differences are preserved in the past memory module 810. The degree of change of the target Query may be computed by the similarity (the seventh affinity information), and the similarity computation method may be found in the above introduction, and will not be repeated here.

The past memory module 810 may preserve locations of five reference features, namely Mem₀ (which may store mask features

$${v}_{0}^{M}$$

and image features

$${k}_{0}^{M} ) ,$$

Memₛ₁ (which may store mask features

$${v}_{s 1}^{M}$$

and image features

$${k}_{s 1}^{M} ) ,$$

Memₛ₂ (which may store mask features

$${v}_{s 2}^{M}$$

may image features

$${k}_{s 2}^{M} ) ,$$

Memₛ₃ (which may store mask features

$${v}_{s 3}^{M}$$

and image features

$${k}_{s 3}^{M} ) ,$$

and Memₛ₄ (which may store mask features

$${v}_{s 4}^{M}$$

and image features

$${k}_{s 4}^{M} ) .$$

In the case that the features in the past memory module 810 are not filled, when the affinity between the target Query of the current frame and the target Query of the previous frame is greater than the second threshold, the reference features of the current frame are updated into the past memory module (e.g., T₂ frames in FIG. 8) 810, and when the affinity is less than the second threshold, the reference features of the current frame may be discarded (e.g., T₁ frame as show in FIG. 8).

In a case where the features in the past memory module 810 have been filled, when the affinity between the target Query of the current frame and the target Query of the previous frame is greater than the second threshold (e.g., Tₜ frames in FIG. 8), the features of the current frame may be fused with the most similar reference features in the past memory module 810, and the reference features of the current frame may be discarded when the affinity is less than the threshold.

The used memory module 820 may include the locations of two reference features, which may be seen in detail in the introduction to FIG. 7, and will not be repeated here.

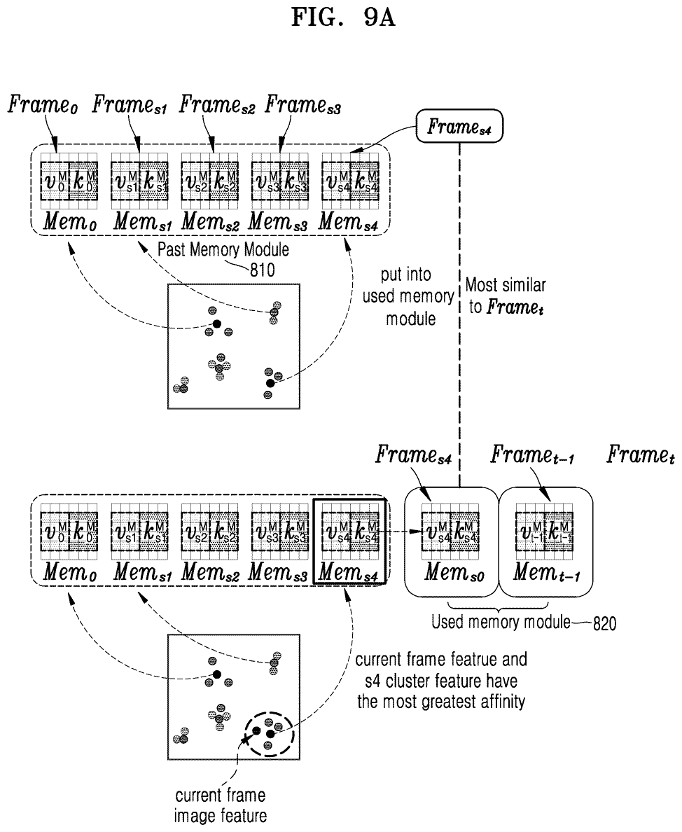

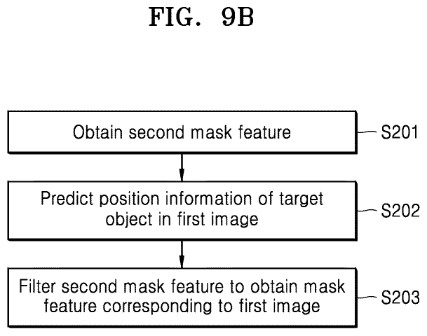

FIG. 9 illustrates a schematic diagram of a reference feature select mechanism according to an embodiment of the disclosure. With respect to the memory update mechanism, an embodiment of the disclosure may also provide a schematic diagram of a reference feature select mechanism, in which after comparing the current frame features with the respective reference features stored in the past memory module 810, the most similar reference feature may be selected as the reference feature during target matching of the current frame as shown in FIG. 9, and an implementation process may be as follows:
(1) The past memory module 810 may be initialized with the reference features of the first image, and if the target query features of a subsequent frame differ significantly from the target query features of the stored frame, then the reference features of the subsequent frame may continue to be added to the past memory module 810.
(2) If the past memory module 810 is full, new reference features may be adaptively merged into the stored reference features to form different reference feature clusters, to reduce the storage of redundant features and to guarantee that the past memory module 810 is organized into useful past states.
(3) The five reference features stored in the past memory module 810 may be used as candidates to compute an affinity between the reference features of the current frame (Frame t) and each reference feature stored in the past memory module 810.
(4) A reference feature with the highest affinity (i.e., the most useful cluster, e.g., Memₛ₄) may be selected as the past reference features (Memₛ₀) to be put into the used memory module 820.
(5) Target object matching may be performed after replacing the previous past reference features with the latest past reference features.

In the embodiment of the disclosure, a mask feature corresponding to a first image based on a stored mask feature corresponding to a first image feature and the fifth affinity information may be provided as shown in FIG. 9B. FIG. 9B illustrates a process for obtaining a mask feature corresponding to a first image based on a stored mask feature corresponding to a first image feature and the fifth affinity information according to an embodiment of the disclosure.

Operation S201 of FIG. 9B includes: obtaining a second mask feature based on the mask feature corresponding to the first image feature and the fifth affinity information.

The second mask feature may be understood as a mask feature preliminarily calibrated to the first image, which may also be referred to as a pixel matching result, and an implementation may be referred to the above introduction, and will not be repeated here.

Operation S202 of FIG. 9B includes: predicting position information of the target object in the first image based on historical position information of the target object.

The operation may be performed using a motion track module.

Operation S203 of FIG. 9B includes: filtering the second mask feature to obtain the mask feature corresponding to the first image, based on the position information of the target object in the first image.

In the embodiment of the disclosure, the motion track module may filter out mis-matching results (interferences) that are far away by predicting the position information of the target object in the current frame, such that the mask feature corresponding to the first image obtained eventually may be understood as a mask feature that is more accurately calibrated to the first image.

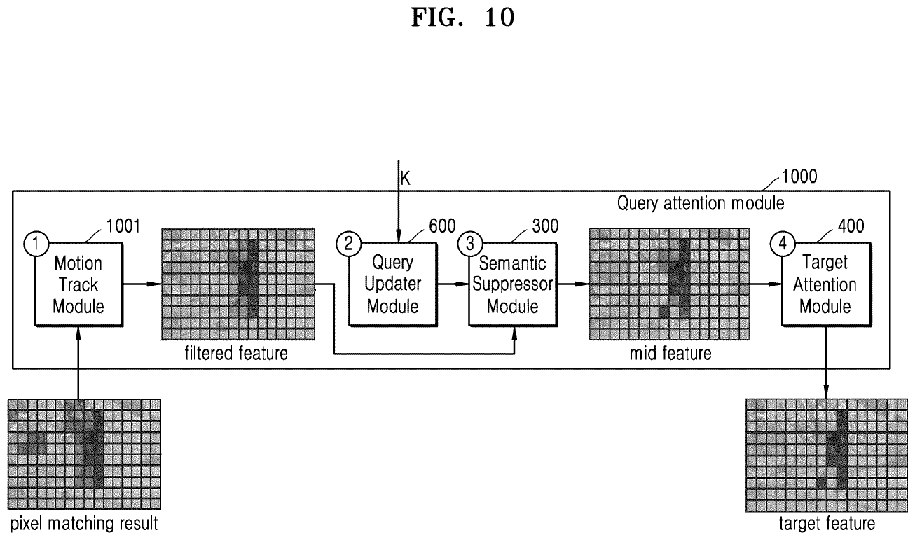

FIG. 10 illustrates a schematic diagram of a processing method of a Query attention module according to an embodiment of the disclosure. For example, an execution method of the Query attention module 1000 including the motion track module 1001 may be as shown in FIG. 10, and the Query attention module 1000 may utilize the position information and the encoded Query features to optimize the pixel matching results, and an implementation process may be as follows.

\textcircled{1} The motion track module 1001 may utilize the historical position information of the target object to predict the position of the target object in the current frame, and filter erroneous features according to the position information from pixel mis-matching results (the second mask features) to obtain the filtered features (the mask feature corresponding to the first image).

\textcircled{2} The Query updater module 600 may update the three Queries (the target Query, the background Query, and the others Query) frame by frame using an image feature Key.

\textcircled{3} The semantic suppressor module 300 may use the others Query and the background Query as guidance to optimize the filtered features to obtain middle features (such as the semantic-guided features described above). In FIG. 3A, the calibrated features may be replaced with the filtered features.

\textcircled{4} The target attention module 400 may use the target Query as guidance, perform feature strengthening of the target object on the middle features after semantic suppression to obtain the target features (such as the target-guided features described above), and update the target Query at the same time.

In the embodiment of the disclosure, operation S202 of FIG. 9B may include: obtaining, based on the historical position information, motion parameters of the at least one second image with respect to the first image using a convolutional neural network; and obtaining, based on position information of the at least one second image and the motion parameters, the position information of the target object in the first image.

As an example of frame-by-frame processing from front to back, the second image may be the previous frame of the current frame image.

As an example, the position information of the target object in the first image may be determined by the following motion equations:

$$\begin{matrix}{x}_{1 , t} = {α}_{x 1} {x}_{1 , t - 1}^{2} + {β}_{x 1} {x}_{1 , t - 1} + {ε}_{x 1} - ϕ \\ {y}_{1 , t} = {α}_{y 1} {y}_{1 , t - 1}^{2} + {β}_{y 1} {y}_{1 , t - 1} + {ε}_{y 1} - ϕ \\ {x}_{2 , t} = {α}_{x 2} {x}_{2 , t - 1}^{2} + {β}_{x 2} {x}_{2 , t - 1} + {ε}_{x 2} + ϕ \\ {y}_{2 , t} = {α}_{y 2} {y}_{2 , t - 1}^{2} + {β}_{y 2} {y}_{2 , t - 1} + {ε}_{y 2} + ϕ\end{matrix}$$

where, (x_{1,t-1}, y_{1,t-1}) and (x_{2,t-1}, y_{2,t-1}) are the position information of the target object in the previous frame (the second image) (which may be position coordinates, such as upper-left and lower-right coordinates of the target object's position box), c_{i,t}=α_{ci}c_{i,t-1}²+β_{ci}c_{i,t-1}+ε_{ci}+φ, where cᵢ denotes the coordinates x or y, i=1 or 2, α, β and ε are the motion parameters, and φ denotes the extension of the target object position box.

In the embodiment of the disclosure, the convolutional neural network used in this operation may also be referred to as a motion evaluation module.

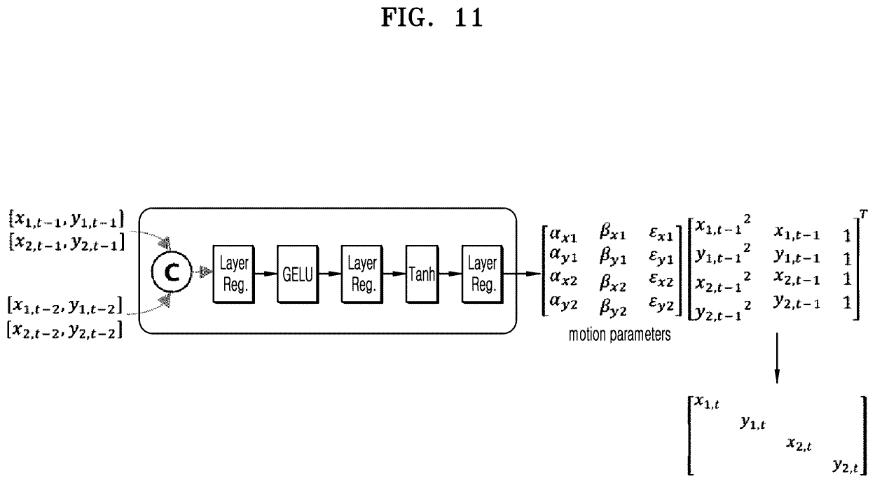

FIG. 11 illustrates a schematic diagram of a motion evaluation module according to an embodiment of the disclosure. For example, a neural network used by the motion evaluation module may be as shown in FIG. 11. The motion evaluation module may include at least one layer regularization (layer reg.), a Gaussian Error Linear Unit (GELU) activation function, and a hyperbolic tangent (Tanh) activation function, but is not limited thereto, and other structures and/or functions may be used. The neural network used by the motion evaluation module may receive an input of position coordinates [x_{1,t-1}, y_{1,t-1}], [x_{2,t-1}, y_{2,t-1}], [x_{1,t-2}, y_{1,t-2}], [x_{2,t-2}, y_{2,t-2}] of the target object in previous two frames, through the motion evaluation module, output the motion parameters

$$[ \begin{matrix}{α}_{x 1} & {β}_{x 1} & {ε}_{x 1} \\ {α}_{y 1} & {β}_{y 1} & {ε}_{y 1} \\ {α}_{x 2} & {β}_{x 2} & {ε}_{x 2} \\ {α}_{y 2} & {β}_{y 2} & {ε}_{y 2}\end{matrix} ]$$

of a previous frame with respect to the current frame, and use the motion parameter matrix to be multiplied with the position coordinates

$${[ \begin{matrix}{x}_{1 , t - 1}^{2} & {x}_{1 , t - 1} & 1 \\ {y}_{1 , t - 1}^{2} & {y}_{1 , t - 1} & 1 \\ {x}_{2 , t - 1}^{2} & {x}_{2 , t - 1} & 1 \\ {y}_{2 , t - 1}^{2} & {y}_{2 , t - 1} & 1\end{matrix} ]}^{T}$$

of the previous frame to obtain the position coordinates

$$[ \begin{matrix}{x}_{1 , t} & & & \\ & {y}_{1 , t} & & \\ & & {x}_{2 , t} & \\ & & & {y}_{2 , t}\end{matrix} ]$$

of the current frame.

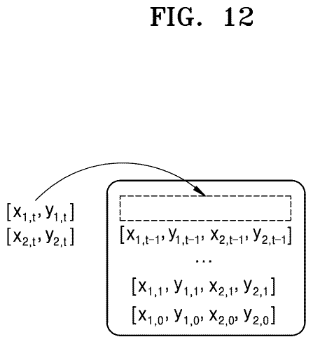

FIG. 12 illustrates a schematic diagram of an operation of a motion evaluation module according to an embodiment of the disclosure. In FIG. 12, a process of storing and utilizing the coordinates [x_{1,t}, y_{1,t}], [x_{2,t}, y_{2,t}] (or position information of the target object) obtained from the current frame, along with the coordinates [x_{1,t-1}, y_{1,t-1}], [x_{2,t-1}, y_{2,t-1}], [x_{1,1}, y_{1,1}], [x_{2,1}, y_{2,1}], [x_{1,0}, y_{1,0}], [x_{2,0}, y_{2,0}] (or position information of the target object) from past frames, is visualized.

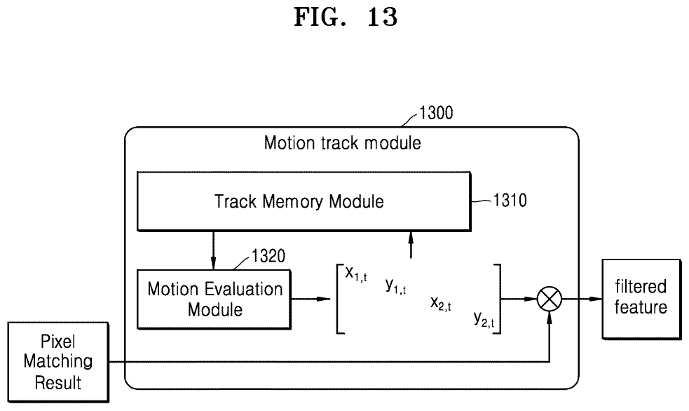

FIG. 13 illustrates a schematic diagram of a processing method of a motion track module 1300 according to an embodiment of the disclosure. As shown in FIG. 13, the position coordinates of the current frame may be stored for prediction of the position coordinates of a next frame.

In the embodiment of the disclosure, a track memory module 1310 may be used to be responsible for storing the position coordinates of the target object, as shown in FIG. 13, and the motion track module 1300 may include the track memory module 1310 and the motion evaluation module 1320, where the motion track module 1300 utilizes the historical positional information of the target object to infer the positional information of the target object in the current frame (e.g., the first image), and filters the mis-matching results at a distance based on the positional information, and an example implementation process may be as follows:
(1) The track memory module 1310 may store the historical position information of the target object.
(2) The motion evaluation module 1320 may utilize the historical position information of the target object, and the motion equations to compute the motion parameters of the target object from the last second image for which the target object segmentation has been performed to the first image, and utilize a position coordinate matrix of the last second image for which the target object segmentation has been performed to be multiplied with the motion parameters to obtain the position coordinates of the target object in the first image, and store the position coordinates of the first image to the track memory module 1310.
(3) The pixel mis-matching results (the second mask features) may be filtered according to the position information of the first image (e.g., by multiplying, but not limited thereto, and other filtering methods may also be used) to obtain the filtered features (the mask feature corresponding to the first image).

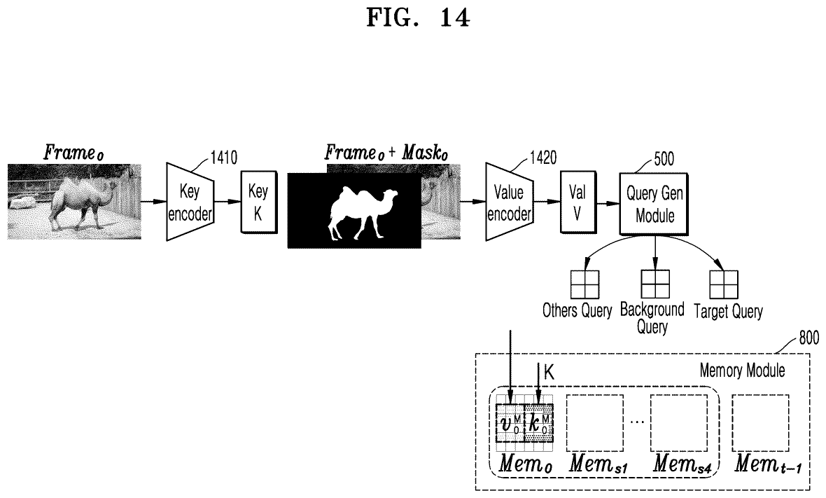

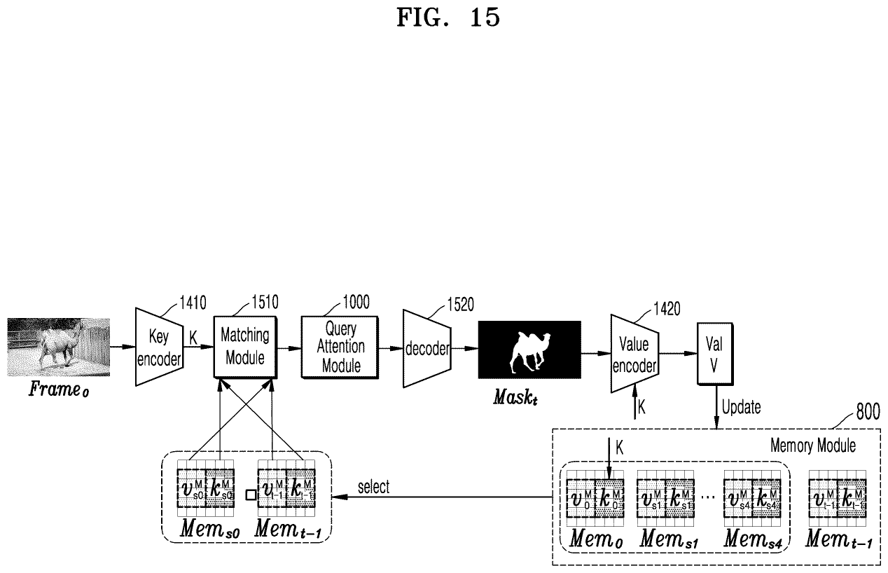

FIG. 14 and FIG. 15 illustrate a schematic diagram of a video object segmentation method according to an embodiment of the disclosure. An embodiment of the disclosure may provide a target-aware video object segmentation method capable of optimizing the pixel matching results by using high-level cumulative features, and guaranteeing the validity of reference features by means of a memory update mechanism, and examples of a flow are shown in FIG. 14 and FIG. 15 by taking the user specifying a target object in a first frame image as an example:
(1) The user may select the target object in the first frame image (Frame₀) to generate a corresponding first mask (Mask0).
(2) Referring to FIG. 14, for the first frame image, a Key feature (image feature or Key K) may be first encoded with a Key encoder 1410 based on the first frame image, and a Value feature (mask feature or Val V) may be encoded with a Value encoder 1420 based on the first frame image, the first mask, and the Key feature, and these two features may be stored into a memory module 800. The Query generation module 500 may be used to generate the target object from the Value feature and the Key feature to preliminarily extract a target Query, a background Query, and the others Query for initialization, where the target Query denotes the accumulation of target object information in the history information, the background Query denotes the accumulation of background information in the history information, and the others Query denotes the accumulation of other object information in the history information.
(3) Referring to FIG. 15, for subsequent frames (e.g., Frameₜ), firstly, image information may be encoded into the Key features (K) by the Key encoder 1410. A matching module 1510 may perform an affinity computation on features (e.g., Memₛ₀) selected based on the memory update mechanism that are most similar to the current frame and the most recent frame features including the target object (e.g., Memₜ₋₁) to obtain a similarity matrix, which is matrix multiplied with corresponding Value features (or Val V) to obtain the Value features preliminarily calibrated to the current frame. The Query attention module 1000 may be used to predict the position of the target object in the current frame and filter out erroneous features far away from the target object, then suppress the semantic information of “background” and “other objects” by using the background Query and the others Query as guidance, and strengthen the features of the target object by using the target Query, to optimize the pixel matching results. After the optimized features may be passed through a decoder 1520, the predicted result Mask (e.g., Maskₜ) of the target object in the current frame may be obtained. Finally, through judgment of the update mechanism, it may be determined whether to update the Key features and the predicted result Mask of the current frame with the Value features encoded by the Value encoder 1420 to the Memory Module 800 or not.

The memory module 800 may guarantee the validity of memory features by preserving the clustered features of the historical memory features and updating these features when processing the subsequent frames, and selecting the most similar features to the current frame for target matching in the matching module 1510. An example implementation may be found in the introduction above, and will not be repeated.

The target-aware high-performance video object segmentation method provided by the embodiment of the disclosure may at least solve the technical problems arising from the following reasons in Table 1:

TABLE 1

| Problem | Reason | Solutions of the embodiment of the disclosure |
|---|---|---|
| Mis-segmentation | Matching at a | 1) Accurately encode three historical cumulative features: |
| of target object to | pixel-level | Target Query, Others Query, and Background Query. |
| similar objects | results in | Suppress “background” and “other objects” semantics by |
| | mis-matching | using the background Query and the others Query as |
| | onto objects | guidance, and strengthen target object features by using |
| | where similar | the target Query as guidance. |
| | pixels exist | The target Query accumulates instance information in |
| | | history frames (e.g., pose, action, part affiliation) |
| | | The background Query accumulates “background” |
| | | semantic information in history frames |
| | | The others Query accumulates semantic information of |
| | | “other objects” in history frames |
| Missing | Large | 2) Guarantee the validity of reference features through the |
| segmentation due | changes in | memory update mechanism. This mechanism keeps a |
| to large object | objects cause | limited number of clusters of the historical features and |
| changes | the fixed first | constantly updates these features during the processing of |
| | image | subsequent frames. In the process of target matching, the |
| | reference to | mechanism guarantees the validity of reference features |
| | fail | by selecting a feature with the highest affinity to the |
| | | current frame as a reference feature. |

In an embodiment, the video object segmentation method according to the embodiment of the disclosure may at least solve the problem that the related art is prone to erroneously match to other objects when similar objects exist on a screen, and as an example, may solve the problem that occurs in the following scenarios:
(1) The video records the process of a person passing by a wall, and due to the existence of affinity between the jacket of the target person and the background wall, the existing methods are prone to erroneously segment the target object (target person) to the background wall, whereas the video object segmentation method according to the embodiment of the disclosure may accurately encode features representing the target object (the target person), and the background (the background wall) by incorporating semantic-level and instance-level information as guidance, and by suppressing the semantic category of “background” and augmenting the semantics of “target object.” Accordingly, the features of the target object may be strengthened, and the target person and background wall may be accurately segmented.
(2) The video records the process of a person passing by another person, and due to an affinity between a face of the target person and a face of the other person, an affinity between an arm and a hand of the target person and an arm and a hand of the other person, and an affinity between clothes of the target person and clothes of the other person in terms of color and texture, etc., the existing methods are prone to erroneously segment to the face, arm, hand and/or clothes of the target object (target person to those of the other person. In contrast, the video object segmentation method according to the embodiment of the disclosure may accurately encode features representing the target object (the target person), and other objects (the other person) by incorporating semantic-level and instance-level information as guidance, and by suppressing the semantic category of “other object” and strengthening the semantics of “target object.” Accordingly, the features of the target object may be strengthened, and the two persons may be accurately segmented.
(3) The video records the process of a child riding a bicycle, and the child riding the bicycle is selected as the target object, and a coat of the child and an umbrella at a distance on a screen look very similar in appearance, and the existing methods are prone to erroneously segment the target object (the child) to the umbrella, while the video object segmentation method according to the embodiment of the disclosure may accurately encode features representing the target object (the child) and other objects (the umbrella) by incorporating semantic-level and instance-level information as guidance, and by suppressing the semantic category of “other objects” and strengthening the semantics of the “target object.” Accordingly, the features of the target object may be strengthened, and the child and the umbrella may be accurately segmented.
(4) The video records the process of rotating a dining table, and a certain plate for serving food is selected as the target object. On the screen, the plate looks similar in appearance to a tablecloth or other plates, and the existing methods are prone to erroneously segment the target object (the plate for serving food) to the tablecloth and other plates, while the video object segmentation method according to the embodiment of the disclosure may accurately encode features representing the target object (the plate for serving food), the background (the tablecloth), and other objects (other plates) by incorporating semantic-level and instance-level information as guidance, and by suppressing the semantic categories of “background” and “other objects” and strengthening the semantics of “target object.” Accordingly, the features of the target object may be strengthened, and each plate and tablecloth may be accurately segmented.

In addition, the video object segmentation method according to the embodiment of the disclosure may at least solve the problem of missing segmentation of the target object easily caused by the related art when the first image reference feature fails due to a large change in the screen, and as an example, may solve the problem that occurs in the following scenarios:
(1) The video records the process of a person driving a motorcycle from far to near, and the motorcycle is selected as the target object. The motorcycle in the screen gradually changes from complete display to partial display, and this large change of the target object makes the related art constantly refer to the first image, thus easily causing the problem of missing segmentation. The video object segmentation method according to the embodiment of the disclosure, considering that fixing a reference frame is not robust enough for scenes with large changes in the object, may avoid a failure of the reference features by introducing a memory update mechanism to update the reference features frame-by-frame to guarantee the validity of reference features, and select the most similar reference features to perform the target object matching in the inference stage to guarantee the validity of reference features. Accordingly, the target object (the motorcycle) may be accurately segmented.
(2) The video records the process of a child riding a bicycle, and the child riding the bicycle is selected as the target object, and the child riding the bicycle on the screen has a large change from far to near, while the first image loses its reference significance, and thus the existing methods are prone to lead to the problem of missing segmentation of the target object. The video object segmentation method according to the embodiment of the disclosure, considering that fixing a reference frame is not robust enough for scenes with large changes in the object, may avoid the failure of the reference features by introducing a memory update mechanism to update the reference features frame-by-frame to guarantee the validity of reference features, and select the most similar reference features to perform the target object matching in the inference stage to guarantee the validity of reference features. Accordingly, the target object (the child) may be accurately segmented.
(3) The video records the process of rotating a dining table, and a plate for serving food is selected as the target object. In the screen, the plate and the tablecloth or other plates are very similar in appearance, and thus the existing methods are prone to the inaccuracy of segmentation of the target object in the first image, which may in turn lead to the problem of missing segmentation of other frames in the video. The video object segmentation method according to an embodiment of the disclosure may accurately encode features representing the target object (a certain plate for serving food), the background (tablecloth), and other objects (other plates) by incorporating semantic-level and instance-level information as guidance, and by suppressing the semantic categories of “background” and “other objects” and strengthening the semantics of “target object”, the features of the target object are strengthened. Considering that the fixed reference frame is not robust enough for scenes with large changes in the object, may avoid the failure of the reference features by introducing a memory update mechanism to update the reference features frame-by-frame to guarantee the validity of reference features, and select the most similar reference features to perform the target object matching in the inference stage to guarantee the validity of reference features. Accordingly, the target object (each plate and tablecloth) may be accurately segmented.

For example, the video recorded the process of Person A walking between Person B and a wall, and the video object segmentation method according to an embodiment of the disclosure may solve the problem by means of the Query attention module in response to the occurrence of a mismatch when predicting similar objects in the related art. For example, the mismatch results on the background wall that is far away from the target object but has similar texture as the target object may be filtered out by predicting the position of the target object in the current frame through the motion track module. For example, mismatch with other persons in close proximity, the Query features may be updated by the Query updater module, then irrelevant semantics may be suppressed by using the semantic suppressor module, and finally, the target features may be strengthened by the target attention module. Accordingly, the problem of mismatch of the neighboring and similar objects may be solved.

The video object segmentation method according to the embodiment of the disclosure may realize many post-processing tasks, such as removing an object and filling the background based on the segmented object regions in the video. For example, the video object segmentation may be used to add a special effect to the object in the video, such as adding a residual shadow and a current effect to a street dancer in the video. For example, the object may be edited in the video by the video object segmentation, such as editing and replacing the texture of clothes of a little girl in the video, but not limited thereto.

In the embodiment of the disclosure, an application scenario is provided which may include: upon receiving an operation to delete a target object, providing information of other objects to a user; upon receiving an operation to delete the other objects, deleting the target object and the other objects in the video; or, upon receiving an operation to preserve the other objects, deleting the target object in the video and preserving the other objects in the video.

The other objects may be objects of the same type as the target object, and the other objects and the target object may also be understood as objects having similar semantic features, such as both being humans. In an embodiment, the other objects may be any object other than the target object and the background. For example, the target object may be a person A, and the other objects may be one or more people other than the person A and animals, or the like.

The information of the other objects may be information prompting whether to delete or preserve the other objects, or may be an indication or image display information of the other objects, etc., and the embodiment of the disclosure is not limited here.

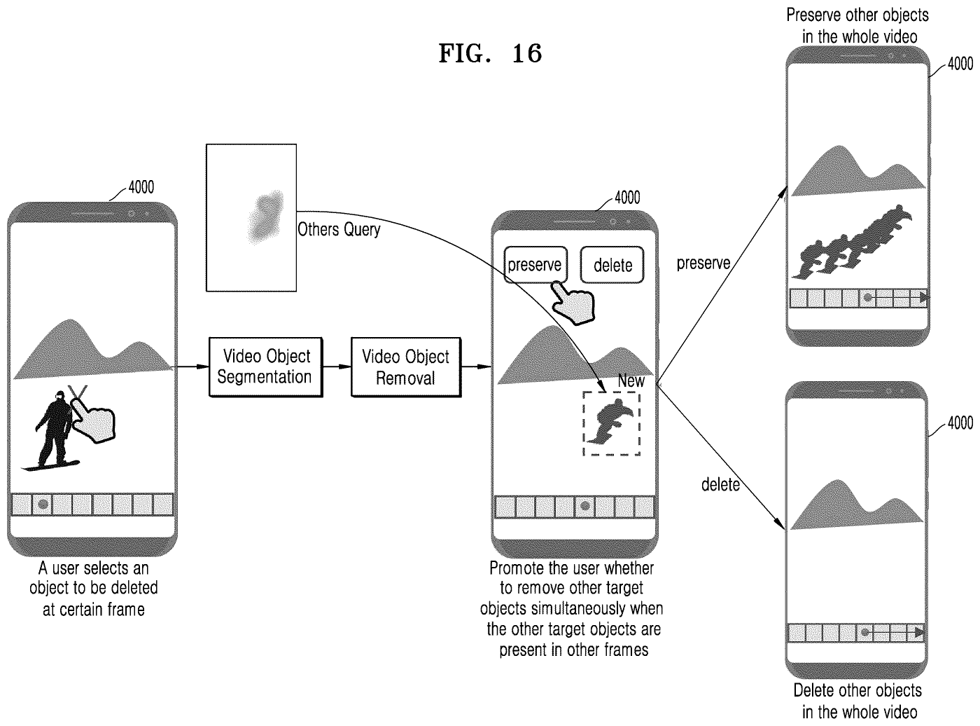

FIG. 16 illustrates a schematic diagram of an application scenario according to an embodiment of the disclosure. As an example, as shown in FIG. 16, the electronic device 4000 may select an object to be deleted in a certain frame image by user input, perform a target object deletion based on video object segmentation and video object deletion in all frames. The electronic device 4000 may provide feedback in the middle of the video as to whether to delete other similar objects because the query features of the other objects may reflect locations of the similar objects, and if the user selects to delete the similar objects, the electronic device 4000 may perform the object segmentation and deletion on the similar objects.

In the embodiment of the disclosure, the electronic device 4000 may also provide an application scenario which may include: upon receiving an operation to only preserve the target object, deleting other objects in the video.

Likewise, the other objects may be objects of the same type as the target object, and the other objects and the target object may also be understood as objects having similar semantic features, such as both being humans. In an embodiment, the other objects are all objects other than the target object and the background. For example, the target object may be a person A, and the other objects may be one or more people other than the person A and animals, or the like.

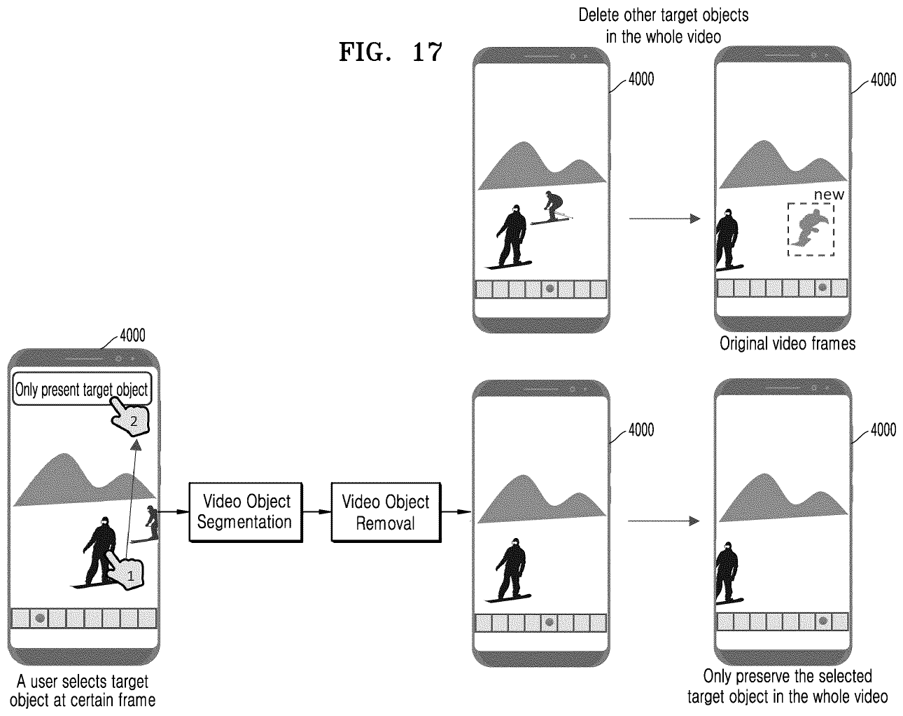

FIG. 17 illustrates a schematic diagram of an application scenario according to an embodiment of the disclosure. As an example, as shown in FIG. 17, a user may select an object to be preserved in the first image, and may select a “preserve the target object only” operation (e.g., clicking a button which may be displayed as other prompts to instruct to delete the other objects but only preserve one object). The other objects may be segmented while performing the video object segmentation in all frames, and because the query features of the other objects may sense the locations of similar objects, the deletion of the other objects may be performed according to the results of segmentation of the other objects, and only the target object of the video may be acquired and preserved.

The technical solutions according to the embodiments of the disclosure may be applied to various electronic devices, including, but not limited to, mobile terminals, smart terminals, and the like, such as smartphones, tablets, laptops, smart wearable devices (e.g., watches, eyeglasses, etc.), smart speakers, in-vehicle terminals, personal digital assistants, portable multimedia players, navigation devices, and the like, but are not limited thereto. It would be understood by those skilled in the art that, in addition to the elements used especially for mobile purposes, the constructions according to the embodiment of the disclosure are also capable of being applied to stationary types of terminals, such as digital televisions, desktop computers, and the like.

The technical solutions according to the embodiment of the disclosure may also be applied to image segmentation in a server, such as a stand-alone physical server, a server cluster or a distributed system composed of a plurality of physical servers, as well as a cloud server that provides basic cloud computing services such as a cloud service, a cloud database, a cloud computing, a cloud function, a cloud storage, a network service, a cloud communication, a middleware service, a domain name service, a security service, a Content Delivery Network (CDN), and a big data and artificial intelligence platform.

As discussed in detail above, the technical solutions according to the embodiment of the disclosure have higher video object segmentation accuracy as compared to the related art.

The embodiment of the disclosure may provide an electronic device 4000 including at least one processor 4001, and optionally further including a transceiver 4004 and/or at least one memory 4003 coupled to the at least one processor 4001, where the at least one processor 4001 is configured to perform the operations of the method according to an embodiment of the disclosure.

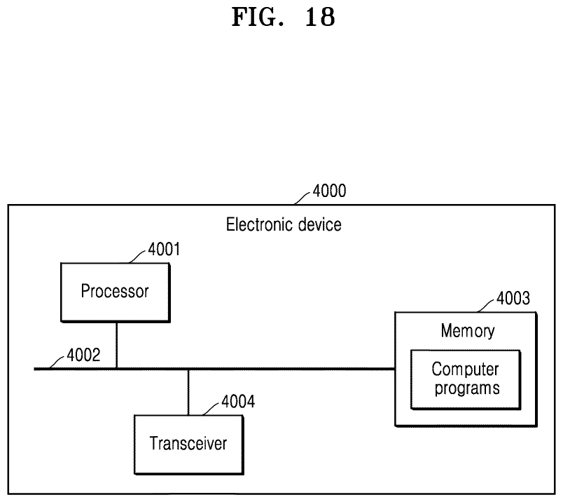

FIG. 18 shows a schematic structure diagram of an electronic device 4000 to which an embodiment of the disclosure is applied. As shown in FIG. 18, an electronic device 4000 shown in FIG. 18 may include at least one processor 4001 and at least one memory 4003. The at least one processor 4001 may be electrically connected to the memory 4003, for example, through a bus 4002. The electronic device 4000 may further include a transceiver 4004 that may be used for data exchange, for example, transmission and reception of data, between the electronic device 4000 and other electronic device. It should be noted that the transceiver 4004 is not limited to one in practical applications, and the structure of the electronic device 4000 does not constitute any limitations to the embodiment of the disclosure. The electronic device 4000 may be a first network node, a second network node or a third network node. The electronic device 4000 may be referred to as a user device or a mobile device associated with a user. The electronic device 4000 may include, but is not limited to, a smartphone, a tablet, a laptop, a personal computer, a smart watch, a smart television, an IoT device, a professional camera (e.g., a digital single-lens reflex (DSLR) camera), and any other electronic device including a display configured to receive a touch input.

The at least one processor 4001 may be a central processing unit (CPU), a general-purpose processor, a digital signal processor (DSP), an application specific integrated circuit (ASIC), a field programmable gate array (FPGA), or other programmable logic devices, transistor logic devices, hardware components, or any combination thereof. The at least one processor 4001 may implement or execute various exemplary logical blocks, modules, and circuits described in connection with the disclosure. The at least one processor 4001 may also be a combination for realizing computing functions, for example, a combination of one or more microprocessors, a combination of a DSP and a microprocessor, etc.

The bus 4002 may include a path to transfer information between the components described above. The bus 4002 may be a peripheral component interconnect (PCI) bus, or an extended industry standard architecture (EISA) bus, etc. The bus 4002 may be an address bus, a data bus, a control bus, etc. For ease of presentation, the bus is represented by only one thick line in FIG. 18. However, it does not mean that there is only one bus or one type of bus.

The memory 4003 may be, but is not limited to, read only memories (ROMs) or other types of static storage devices that may store static information and instructions, random access memories (RAMs) or other types of dynamic storage devices that may store information and instructions, may be electrically erasable programmable read only memories (EEPROMs), compact disc read only memories (CD-ROMs) or other optical disk storages, optical disc storages (including compact discs, laser discs, discs, digital versatile discs, blue-ray discs, etc.), magnetic storage media or other magnetic storage devices, or any other media that may carry or store desired program codes in the form of instructions or data structures and that may be accessed by computers.

The memory 4003 may be used to store a computer program for executing the solutions of the disclosure, and may be controlled by the at least one processor 4001. The at least one processor 4001 may be used to execute the computer program stored in the memory 4003 to implement the solution provided in any method embodiment described above.

An embodiment of the disclosure provide a computer-readable storage medium having a computer program stored on the computer-readable storage medium, the computer program, when executed by a processor, may implement the operations and/or corresponding contents of any one of the foregoing method embodiment(s).

In an embodiment, the second feature corresponding to the other regions comprises a second feature corresponding to a background and/or a second feature corresponding to other objects.

In an embodiment, the performing the second processing comprises obtaining a third feature based on the determined second feature and the mask feature corresponding to the first image, the third feature characterizing a feature corresponding to the other regions existing in the mask feature, and removing the third feature from the mask feature corresponding to the first image.

In an embodiment, the performing the first processing comprises determining an affinity between the determined first feature and the mask feature corresponding to the first image, to obtain first affinity information, and processing the mask feature corresponding to the first image based on the first affinity information.

In an embodiment, the method of the disclosure further comprises updating the determined first feature based on the first affinity information.

In an embodiment, the determining the first feature and/or the determining the second feature comprises updating, based on the image feature of the first image, the first feature corresponding to the at least one second image and/or the second feature corresponding to the at least one second image, to obtain the first feature and/or the second feature corresponding to the first image.

In an embodiment, the determining the first feature and/or the determining the second feature comprises at least one of: for at least a portion of the at least one second image, determining a first mask feature corresponding to the at least one second image, and extracting the first feature and/or the second feature corresponding to the at least one second image from the first mask feature; and for each second image except the portion of the at least one second image, updating, based on an image feature of the at least one second image, the first feature and/or the second feature corresponding to the at least one second image for which the target object segmentation has been performed, to obtain the first feature and/or the second feature corresponding to the at least one second image.

In an embodiment, the extracting the first feature and/or the second feature comprises: determining an affinity between the image feature of the at least one second image and the first mask feature, to obtain second affinity information; filtering the second affinity information by using at least one first threshold to obtain affinity information corresponding to the target object and affinity information corresponding to other regions outside the target object, respectively; and obtaining, based on the affinity information corresponding to the target object and the affinity information corresponding to the other regions outside the target object, respectively, and the image feature of the at least one second image, the first feature and/or the second feature corresponding to the at least one second image.

In an embodiment, the updating the first feature and/or the second feature corresponding to the at least one second image comprises: determining an affinity between the image feature of the first image and the first feature corresponding to the at least one second image, to obtain third affinity information; determining an affinity between the image feature of the first image and the second feature corresponding to the at least one second image, to obtain fourth affinity information; normalizing the third affinity information and the fourth affinity information; obtaining the first feature corresponding to the first image, based on the normalized third affinity information and the first feature corresponding to the at least one second image; and obtaining the second feature corresponding to the first image, based on the normalized fourth affinity information and the second feature corresponding to the at least one second image.

In an embodiment, the method of the disclosure further comprises: determining a first image feature that is most similar to the image feature of the first image among at least one target image feature, and fifth affinity information between the most similar first image feature and the first image; and obtaining the mask feature corresponding to the first image based on a mask feature corresponding to the first image feature and the fifth affinity information, the at least one target image feature is an image feature of at least a portion of the at least one second image.

In an embodiment, the obtaining the mask feature corresponding to the first image based on the mask feature corresponding to the first image feature and the fifth affinity information comprises: determining a second image feature corresponding to a last second image for which the target object segmentation has been performed and which contains the target object in the at least one second image, and sixth affinity information between the second image feature and the first image; and obtaining the mask feature corresponding to the first image based on the mask feature corresponding to the first image feature, the fifth affinity information, a mask feature corresponding to the second image feature, and the sixth affinity information.

In an embodiment, the method of the disclosure further comprises: for each second image of the at least one second image, determining an affinity between a first feature corresponding to a second image and the first feature corresponding to the for which the target object segmentation has been performed before another second image, to obtain seventh affinity information; and based on the seventh affinity information being greater than a second threshold, using the image feature of the second image as a target image feature, and storing the target image feature and a corresponding mask feature of the target image feature.

In an embodiment, the method of the disclosure further comprises, before the storing: determining a third image feature that is most similar to the image feature of the second image among stored target image features, based on a number of stored image features reaching a predetermined number, the storing comprises: fusing the third image feature and a corresponding mask feature of the third image feature with the image feature of the second image and a corresponding mask feature of the second image; and updating a stored third image feature and a stored corresponding mask feature of the third image feature to the fused image feature and corresponding mask feature.

In an embodiment, the obtaining the mask feature corresponding to the first image based on the mask feature corresponding to the first image feature and the fifth affinity information comprises: obtaining a second mask feature based on the mask feature corresponding to the first image feature and the fifth affinity information; predicting position information of the target object in the first image based on historical position information of the target object; and filtering the second mask feature to obtain the mask feature corresponding to the first image, based on the position information of the target object in the first image.

In an embodiment, the predicting the position information comprises: obtaining, based on the historical position information, a motion parameter of the at least one second image with respect to the first image using a convolutional neural network; and obtaining, based on position information of the at least one second image and the motion parameter, the position information of the target object in the first image.

In an embodiment, the method of the disclosure further comprises: upon receiving an operation instruction to delete the target object, providing information of other objects to a user, and upon receiving an operation instruction to delete the other objects, deleting the target object and the other objects in the video; and upon receiving an operation instruction to preserve only the target object, deleting the other objects in the video.

An embodiment of the disclosure may also provide a computer program product including a computer program that, when executed by a processor, realizes the operations and corresponding contents of the preceding method embodiments.

The terms “first”, “second”, “third”, “fourth”, “1”, “2”, etc. (if present) in the specification and claims of this application and the accompanying drawings above are used to distinguish similar objects and need not be used to describe a particular order or sequence. It should be understood that the data so used is interchangeable where appropriate such that embodiments of the disclosure described herein may be implemented in an order other than that illustrated or described in the text.

It should be understood that while the flow diagram of an embodiment of the disclosure indicates the individual operational operations by arrows, the order in which these operations are performed is not limited to the order indicated by the arrows. Unless explicitly stated herein, in some implementation scenarios of embodiments of the disclosure, the implementation operations in the respective flowcharts may be performed in other orders as desired. In addition, some, or all of the operations in each flowchart may include multiple sub-operations or multiple phases based on the actual implementation scenario. Some or all of these sub-operations or stages may be executed at the same moment (or time), and each of these sub-operations or stages may also be executed at different moments (or times) separately. The order of execution of these sub-operations or stages may be flexibly configured according to requirements in different scenarios of execution time, and the embodiments of the disclosure are not limited thereto.

The above-mentioned description and the drawings are provided merely as examples to help readers understand the disclosure, and they should not be interpreted or aim to limit the scope of the disclosure in any way. Although an embodiment is provided, it is apparent for those skilled in the art to adopt other similar implementation means based on the technical idea of the disclosure without departing from the technical concept of the solution of the disclosure.

What is claimed is:

1. A method performed by an electronic device, the method comprising:
determining, based on an image feature of a first image in a video and a first feature corresponding to a target object in at least one second image for which target object segmentation has been performed in the video, a first feature corresponding to the target object in the first image, and performing, based on the determined first feature, first processing on a mask feature corresponding to the first image; and/or
determining, based on the image feature of the first image and a second feature corresponding to other regions other than the target object in the at least one second image for which the target object segmentation has been performed in the video, a second feature corresponding to the other regions other than the target object in the first image, and performing, based on the determined second feature, second processing on the mask feature corresponding to the first image; and
determining, based on a result of the first processing and/or a result of the second processing, a result of performing the target object segmentation on the first image.

2. The method of claim 1, wherein the second feature corresponding to the other regions comprises a second feature corresponding to a background and/or a second feature corresponding to other objects.

3. The method of claim 1, wherein the performing the second processing comprises:
obtaining a third feature based on the determined second feature and the mask feature corresponding to the first image, the third feature characterizing a feature corresponding to the other regions existing in the mask feature; and
removing the third feature from the mask feature corresponding to the first image.

4. The method of claim 1, wherein the performing the first processing comprises:
determining an affinity between the determined first feature and the mask feature corresponding to the first image, to obtain first affinity information; and
processing the mask feature corresponding to the first image based on the first affinity information.

5. The method of claim 4, further comprising:
updating the determined first feature based on the first affinity information.

6. The method of claim 1, wherein the determining the first feature and/or the determining the second feature comprises:
updating, based on the image feature of the first image, the first feature corresponding to the at least one second image and/or the second feature corresponding to the at least one second image, to obtain the first feature and/or the second feature corresponding to the first image.

7. The method of claim 6, wherein the determining the first feature and/or the determining the second feature comprises at least one of:
for at least a portion of the at least one second image, determining a first mask feature corresponding to the at least one second image, and extracting the first feature and/or the second feature corresponding to the at least one second image from the first mask feature; and
for each second image except the portion of the at least one second image, updating, based on an image feature of a second image, the first feature and/or the second feature corresponding to another second image for which the target object segmentation has been performed before the second image, to obtain the first feature and/or the second feature corresponding to the second image.

8. The method of claim 7, wherein the extracting the first feature and/or the second feature comprises:
determining an affinity between the image feature of the at least one second image and the first mask feature, to obtain second affinity information;
filtering the second affinity information by using at least one first threshold to obtain affinity information corresponding to the target object and affinity information corresponding to other regions outside the target object, respectively; and
obtaining, based on the affinity information corresponding to the target object and the affinity information corresponding to the other regions outside the target object, respectively, and the image feature of the at least one second image, the first feature and/or the second feature corresponding to the at least one second image.

9. The method of claim 6, wherein the updating the first feature and/or the second feature corresponding to the at least one second image comprises:
determining an affinity between the image feature of the first image and the first feature corresponding to the at least one second image, to obtain third affinity information;
determining an affinity between the image feature of the first image and the second feature corresponding to the at least one second image, to obtain fourth affinity information;
normalizing the third affinity information and the fourth affinity information;
obtaining the first feature corresponding to the first image, based on the normalized third affinity information and the first feature corresponding to the at least one second image; and
obtaining the second feature corresponding to the first image, based on the normalized fourth affinity information and the second feature corresponding to the at least one second image.

10. The method of claim 1, further comprising:
determining a first image feature that is most similar to the image feature of the first image among at least one target image feature, and fifth affinity information between the most similar first image feature and the first image; and
obtaining the mask feature corresponding to the first image based on a mask feature corresponding to the first image feature and the fifth affinity information,
wherein the at least one target image feature is an image feature of at least a portion of the at least one second image.

11. The method of claim 10, wherein the obtaining the mask feature corresponding to the first image based on the mask feature corresponding to the first image feature and the fifth affinity information comprises:
determining a second image feature corresponding to a last second image for which the target object segmentation has been performed and which contains the target object in the at least one second image, and sixth affinity information between the second image feature and the first image; and
obtaining the mask feature corresponding to the first image based on the mask feature corresponding to the first image feature, the fifth affinity information, a mask feature corresponding to the second image feature, and the sixth affinity information.

12. The method of claim 10, further comprising:
for each second image of the at least one second image, determining an affinity between a first feature corresponding to a second image and the first feature corresponding to the for which the target object segmentation has been performed before another second image, to obtain seventh affinity information; and
based on the seventh affinity information being greater than a second threshold, using the image feature of the second image as a target image feature, and storing the target image feature and a corresponding mask feature of the target image feature.

13. The method of claim 12, further comprising, before the storing:
determining a third image feature that is most similar to the image feature of the second image among stored target image features, based on a number of stored image features reaching a predetermined number,
wherein the storing comprises:
fusing the third image feature and a corresponding mask feature of the third image feature with the image feature of the second image and a corresponding mask feature of the second image; and
updating a stored third image feature and a stored corresponding mask feature of the third image feature to the fused image feature and corresponding mask feature.

14. The method of claim 10, wherein the obtaining the mask feature corresponding to the first image based on the mask feature corresponding to the first image feature and the fifth affinity information comprises:
obtaining a second mask feature based on the mask feature corresponding to the first image feature and the fifth affinity information;
predicting position information of the target object in the first image based on historical position information of the target object; and
filtering the second mask feature to obtain the mask feature corresponding to the first image, based on the position information of the target object in the first image.

15. The method of claim 14, wherein the predicting the position information comprises:
obtaining, based on the historical position information, a motion parameter of the at least one second image with respect to the first image using a convolutional neural network; and
obtaining, based on position information of the at least one second image and the motion parameter, the position information of the target object in the first image.

16. The method of claim 1, further comprising:
upon receiving an operation instruction to delete the target object, providing information of other objects to a user, and upon receiving an operation instruction to delete the other objects, deleting the target object and the other objects in the video; and
upon receiving an operation instruction to preserve only the target object, deleting the other objects in the video.

17. An electronic device comprising:
at least one memory configured to store a computer program; and
at least one processor configured to execute the computer program to perform:
determining, based on an image feature of a first image in a video and a first feature corresponding to a target object in at least one second image for which target object segmentation has been performed in the video, a first feature corresponding to the target object in the first image, and performing, based on the determined first feature, first processing on a mask feature corresponding to the first image; and/or
determining, based on the image feature of the first image and a second feature corresponding to other regions other than the target object in the at least one second image for which the target object segmentation has been performed in the video, a second feature corresponding to the other regions other than the target object in the first image, and performing, based on the determined second feature, second processing on the mask feature corresponding to the first image; and
determining, based on a result of the first processing and/or a result of the second processing, a result of performing the target object segmentation on the first image.

18. The electronic device of claim 14, wherein the second feature corresponding to the other regions comprises a second feature corresponding to a background and/or a second feature corresponding to other objects.

19. The electronic device of claim 14, wherein the second processing comprises:
obtaining a third feature based on the determined second feature and the mask feature corresponding to the first image, the third feature characterizing a feature corresponding to the other regions existing in the mask feature; and
removing the third feature from the mask feature corresponding to the first image.

20. A non-transitory computer readable storage medium having stored thereon a computer program that, when executed by at least one processor, perform:
determining, based on an image feature of a first image in a video and a first feature corresponding to a target object in at least one second image for which target object segmentation has been performed in the video, a first feature corresponding to the target object in the first image, and performing, based on the determined first feature, first processing on a mask feature corresponding to the first image; and/or
determining, based on the image feature of the first image and a second feature corresponding to other regions other than the target object in the at least one second image for which the target object segmentation has been performed in the video, a second feature corresponding to the other regions other than the target object in the first image, and performing, based on the determined second feature, second processing on the mask feature corresponding to the first image; and
determining, based on a result of the first processing and/or a result of the second processing, a result of performing the target object segmentation on the first image.
